(19) United States
(12) Patent Application Publication
(10) Pub. No.: US 2025/0300800 A1
(43) Pub. Date: Sep. 25, 2025

(54) BANDWIDTH PART CONFIGURATION FOR FULL-DUPLEX COMMUNICATIONS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/612,923

(22) Filed: Mar. 21, 2024

(51) Int. Cl. H04L 5/16; H04L 5/14; H04W 72/0457; H04W 72/232; H04W 76/20

(52) U.S. Cl. CPC H04L 5/16; H04L 5/1469; H04W 72/0457; H04W 72/232; H04W 76/20

(57) ABSTRACT

Methods, systems, and devices for wireless communications are described. A user equipment (UE) may be capable of communicating in various different duplexing modes, such as a half-duplex mode, a full-duplex mode, or both. For instance, a UE may communicate one or more first messages in accordance with a half-duplex mode in a time division duplexing (TDD) band, and then may switch from the half-duplex mode to a full-duplex mode. To support efficient uplink and downlink communications for the full-duplex mode and to utilize the available uplink and downlink resources of the TDD band more effectively, the UE may communicate one or more second messages in accordance with the full-duplex mode in an uplink bandwidth part (BWP) and a downlink BWP of the TDD band, where the uplink BWP and the downlink BWP are unaligned in center frequency for the full-duplex mode.

### FIELD OF TECHNOLOGY

The following relates to wireless communications, including bandwidth part (BWP) configuration for full-duplex communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support bandwidth part (BWP) configuration for full-duplex communications. For example, the described techniques provide for efficient downlink and uplink BWP pairing configurations for use by a user equipment (UE) that is capable of communicating in both time division duplex (TDD) and frequency division duplex (FDD) deployments using various different duplexing modes, such as a half-duplex mode, a full-duplex mode, or both. For instance, a UE may communicate one or more first messages in accordance with a half-duplex mode in a TDD band, and may then switch from the half-duplex mode to a full-duplex mode. To utilize the available uplink and downlink resources of the TDD band more effectively, the UE may communicate one or more second messages in accordance with the full-duplex mode in an uplink BWP and a downlink BWP of the TDD band, where the uplink BWP and the downlink BWP are unaligned in center frequency for the full-duplex mode.

A method for wireless communications by a user equipment (UE) is described. The method may include communicating one or more first messages in accordance with a half-duplex mode of operation in a TDD band, switching from the half-duplex mode of operation to a full-duplex mode of operation in the TDD band, and communicating one or more second messages in accordance with the full-duplex mode of operation in an uplink BWP and a downlink BWP of the TDD band, where the uplink BWP and the downlink BWP are unaligned in center frequency for the full-duplex mode of operation.

A UE for wireless communications is described. The UE may include one or more memories storing processor executable code, and one or more processors coupled with the one or more memories. The one or more processors may individually or collectively be operable to execute the code to cause the UE to communicate one or more first messages in accordance with a half-duplex mode of operation in a TDD band, switch from the half-duplex mode of operation to a full-duplex mode of operation in the TDD band, and communicate one or more second messages in accordance with the full-duplex mode of operation in an uplink BWP and a downlink BWP of the TDD band, where the uplink BWP and the downlink BWP are unaligned in center frequency for the full-duplex mode of operation.

Another UE for wireless communications is described. The UE may include means for communicating one or more first messages in accordance with a half-duplex mode of operation in a TDD band, means for switching from the half-duplex mode of operation to a full-duplex mode of operation in the TDD band, and means for communicating one or more second messages in accordance with the full-duplex mode of operation in an uplink BWP and a downlink BWP of the TDD band, where the uplink BWP and the downlink BWP are unaligned in center frequency for the full-duplex mode of operation.

A non-transitory computer-readable medium storing code for wireless communications is described. The code may include instructions executable by one or more processors to communicate one or more first messages in accordance with a half-duplex mode of operation in a TDD band, switch from the half-duplex mode of operation to a full-duplex mode of operation in the TDD band, and communicate one or more second messages in accordance with the full-duplex mode of operation in an uplink BWP and a downlink BWP of the TDD band, where the uplink BWP and the downlink BWP are unaligned in center frequency for the full-duplex mode of operation.

Some examples of the method, UEs, and non-transitory computer-readable medium described herein may further include operations, features, means, or instructions for transmitting an indication of a capability of the UE to support the full-duplex mode of operation based on the uplink BWP and the downlink BWP being unaligned in center frequency.

In some examples of the method, UEs, and non-transitory computer-readable medium described herein, the uplink BWP and the downlink BWP may be associated with a same BWP identifier.

In some examples of the method, UEs, and non-transitory computer-readable medium described herein, communicating the one or more second messages may include operations, features, means, or instructions for receiving one or more RRC messages that include a radio resource control (RRC) configuration that indicates a first set of multiple BWP pairings associated with the half-duplex mode of operation and a second set of multiple BWP pairings associated with the full-duplex mode of operation and communicating the one or more second messages in accordance with a first BWP pairing of the second set of multiple BWP pairings associated with the full-duplex mode of operation, where the first BWP pairing includes the uplink BWP and the downlink BWP.

In some examples of the method, UEs, and non-transitory computer-readable medium described herein, the first set of multiple BWP pairings and the second set of multiple BWP pairings may be included in a lookup table as part of the one or more RRC messages.

Some examples of the method, UEs, and non-transitory computer-readable medium described herein may further include operations, features, means, or instructions for switching from the first BWP pairing of the second set of multiple BWP pairings to a second BWP pairing of the first set of multiple BWP pairings based on a corresponding switch from a full duplex slot to a half-duplex slot.

In some examples of the method, UEs, and non-transitory computer-readable medium described herein, the first set of multiple BWP pairings and the second set of multiple BWP pairings may be associated with different respective communication beams, different respective power control parameters, or both.

Some examples of the method, UEs, and non-transitory computer-readable medium described herein may further include operations, features, means, or instructions for receiving, via an RRC configuration message, a first information element associated with the uplink BWP, where the first information element includes an identifier of a respective downlink BWP that corresponds to the uplink BWP, where the uplink BWP and the respective downlink BWP include a BWP pairing to communicate in accordance with the full-duplex mode of operation.

Some examples of the method, UEs, and non-transitory computer-readable medium described herein may further include operations, features, means, or instructions for receiving, via an RRC configuration message, a first information element associated with the downlink BWP, where the first information element includes an identifier of a respective uplink BWP that corresponds to the downlink BWP, where the downlink BWP and the respective uplink BWP include a BWP pairing to communicate in accordance with the full-duplex mode of operation.

Some examples of the method, UEs, and non-transitory computer-readable medium described herein may further include operations, features, means, or instructions for receiving one or more RRC messages that include an RRC configuration that indicates a first set of multiple BWP pairings associated with the half-duplex mode of operation and a corresponding second set of multiple BWP pairings associated with the full-duplex mode of operation, receiving, via a downlink control information message, instruction to switch from a first BWP pairing to a second BWP pairing of the first set of multiple BWP pairings, and switching from a first corresponding BWP pairing to a second corresponding BWP pairing of the corresponding second set of multiple BWP pairings based on the downlink control information message.

Some examples of the method, UEs, and non-transitory computer-readable medium described herein may further include operations, features, means, or instructions for receiving, via an RRC message, a parameter that activates a timer that may be associated with switching between a default BWP and one or more active BWPs and switching from a first active BWP pairing of a half-duplex slot to a second active BWP pairing of a full-duplex slot, where the timer remains active after the switching.

In some examples of the method, UEs, and non-transitory computer-readable medium described herein, the timer includes a BWP inactivity timer.

In some examples of the method, UEs, and non-transitory computer-readable medium described herein, the timer remaining active may include operations, features, means, or instructions for refraining from restarting the timer based on switching a slot type from the half-duplex slot to the full-duplex slot.

A method for wireless communications by a network entity is described. The method may include outputting an indication of a BWP configuration to communicate in a TDD band including at least an uplink BWP and a downlink BWP that are unaligned in center frequency and obtaining one or more first messages in a full-duplex mode of operation in the uplink BWP and the downlink BWP of the TDD band, where the uplink BWP and the downlink BWP are unaligned in center frequency in accordance with the BWP configuration.

A network entity for wireless communications is described. The network entity may include one or more memories storing processor executable code, and one or more processors coupled with the one or more memories. The one or more processors may individually or collectively be operable to execute the code to cause the network entity to output an indication of a BWP configuration to communicate in a TDD band including at least an uplink BWP and a downlink BWP that are unaligned in center frequency and obtain one or more first messages in a full-duplex mode of operation in the uplink BWP and the downlink BWP of the TDD band, where the uplink BWP and the downlink BWP are unaligned in center frequency in accordance with the BWP configuration.

Another network entity for wireless communications is described. The network entity may include means for outputting an indication of a BWP configuration to communicate in a TDD band including at least an uplink BWP and a downlink BWP that are unaligned in center frequency and means for obtaining one or more first messages in a full-duplex mode of operation in the uplink BWP and the downlink BWP of the TDD band, where the uplink BWP and the downlink BWP are unaligned in center frequency in accordance with the BWP configuration.

A non-transitory computer-readable medium storing code for wireless communications is described. The code may include instructions executable by one or more processors to output an indication of a BWP configuration to communicate in a TDD band including at least an uplink BWP and a downlink BWP that are unaligned in center frequency and obtain one or more first messages in a full-duplex mode of operation in the uplink BWP and the downlink BWP of the TDD band, where the uplink BWP and the downlink BWP are unaligned in center frequency in accordance with the BWP configuration.

Some examples of the method, network entities, and non-transitory computer-readable medium described herein may further include operations, features, means, or instructions for obtaining an indication of a capability of a UE to support the full-duplex mode of operation based on the uplink BWP and the downlink BWP being unaligned in center frequency, where the uplink BWP and the downlink BWP may be associated with a same BWP identifier.

In some examples of the method, network entities, and non-transitory computer-readable medium described herein, communicating the one or more first messages may include operations, features, means, or instructions for outputting one or more RRC messages that include an RRC configuration that indicates a lookup table including a first set of multiple BWP pairings associated with a half-duplex mode of operation and a second set of multiple BWP pairings associated with the full-duplex mode of operation and obtaining the one or more first messages in accordance with a first BWP pairing of the second set of multiple BWP pairings associated with the full-duplex mode of operation, where the first BWP pairing includes the uplink BWP and the downlink BWP.

Some examples of the method, network entities, and non-transitory computer-readable medium described herein may further include operations, features, means, or instructions for outputting, via an RRC configuration message, a first information element associated with the uplink BWP or the downlink BWP, where the first information element includes an identifier of a respective downlink BWP or a respective uplink BWP that corresponds to the uplink BWP or the downlink BWP, where the uplink BWP and the respective downlink BWP or the downlink BWP and the respective uplink BWP include a BWP pairing to communicate in accordance with the full-duplex mode of operation.

Some examples of the method, network entities, and non-transitory computer-readable medium described herein may further include operations, features, means, or instructions for outputting one or more RRC messages that include an RRC configuration that indicates a first set of multiple BWP pairings associated with a half-duplex mode of operation and a corresponding second set of multiple BWP pairings associated with the full-duplex mode of operation and outputting, via a downlink control information message, instruction to switch from a first BWP pairing to a second BWP pairing of the first set of multiple BWP pairings.

Some examples of the method, network entities, and non-transitory computer-readable medium described herein may further include operations, features, means, or instructions for outputting, via an RRC message, a parameter that activates a BWP inactivity timer that may be associated with switching between a default BWP and one or more active BWPs, where the BWP inactivity timer remains active after the switching.

### BRIEF DESCRIPTION OF THE DRAWINGS

FIGS. 1, 2, 3, and 4 show examples of wireless communications systems that support bandwidth part (BWP) configuration for full-duplex communications in accordance with one or more aspects of the present disclosure.

FIG. 5 shows an example of a slot configuration that supports BWP configuration for full-duplex communications in accordance with one or more aspects of the present disclosure.

FIG. 6 shows an example of a process flow that supports BWP configuration for full-duplex communications in accordance with one or more aspects of the present disclosure.

FIGS. 7 and 8 show block diagrams of devices that support BWP configuration for full-duplex communications in accordance with one or more aspects of the present disclosure.

FIG. 9 shows a block diagram of a communications manager that supports BWP configuration for full-duplex communications in accordance with one or more aspects of the present disclosure.

FIG. 10 shows a diagram of a system including a device that supports BWP configuration for full-duplex communications in accordance with one or more aspects of the present disclosure.

FIGS. 11 and 12 show block diagrams of devices that support BWP configuration for full-duplex communications in accordance with one or more aspects of the present disclosure.

FIG. 13 shows a block diagram of a communications manager that supports BWP configuration for full-duplex communications in accordance with one or more aspects of the present disclosure.

FIG. 14 shows a diagram of a system including a device that supports BWP configuration for full-duplex communications in accordance with one or more aspects of the present disclosure.

FIGS. 15 through 17 show flowcharts illustrating methods that support BWP configuration for full-duplex communications in accordance with one or more aspects of the present disclosure.

### DETAILED DESCRIPTION

Some wireless communications systems may support full-duplex communications on a frequency division-duplexing (FDD) band, where a device such as a user equipment (UE) may perform simultaneous uplink and downlink communications on uplink and downlink resources spanning different frequencies of the FDD band. The UE may also be configured with one or more bandwidth parts (BWPs), which include a set of frequencies that the UE may use to perform the uplink and downlink communications. In some FDD deployments, downlink BWPs and uplink BWPs may be unpaired, such that any set of configured downlink BWP and uplink BWP can be active at any time. In some other implementations, such as in time-division duplexing (TDD) deployments supporting half-duplex communications, the uplink BWPs and downlink BWPs may be paired, such that when an uplink BWP (for example, uplink BWP 0) is active, then the corresponding downlink BWP (downlink BWP 0) may also be active, with both BWPs sharing a same central frequency.

Maintaining separate BWP configurations in both TDD and FDD deployments, however, may pose challenges for a UE that is capable of full-duplex operations. For example, in TDD deployments, downlink BWPs and uplink BWPs are configured to share a same central frequency, which may lead to a large portion of at least one of the BWPs to be outside of a corresponding band. For example, a central frequency configured for an uplink and downlink BWP pair may be configured in the middle of a guard band between the uplink and downlink bands, which may cause the uplink and downlink BWP to overlap only partially (or be non-overlapping) with the uplink and downlink bands. Additionally, or alternatively, in FDD deployments, frequent switching between half-duplex (e.g., TDD) slots and full-duplex (e.g., FDD) slots may require frequent BWP switching, which may be inefficient for some communications frameworks.

A wireless communications system may implement various techniques to support full-duplex operation for a UE operating in both FDD and TDD bands. For example, in order to more efficiently allocate resources for paired BWPs, the restriction on paired downlink and uplink BWPs having a same central frequency is relaxed, such that the paired uplink and downlink BWPs may have different central frequencies. In some other examples, the network may provide (via radio resource control (RRC) messaging) a table that includes different pairings of downlink and uplink BWPs for half-duplex operation, and corresponding pairings of downlink and uplink BWPs for full-duplex operation, so that the UE can determine which BWPs to use when switching from a half-duplex mode to a full-duplex mode and vice versa. In some such examples, the pairing may be indicated by a lookup table, or may be included within an information element for a corresponding uplink or downlink BWP. In some aspects where the BWP pairing is indicated in a lookup table, the UE may switch between half-duplex and full-duplex BWP pairings based on a switching indication received via downlink control information (DCI), where the DCI triggers a switch in half-duplex BWP pairings and the UE may determine, based on the switch in the half-duplex BWP pairing, which corresponding full-duplex BWP pairing to switch to. In some other examples, switching between half-duplex slots and full-duplex slots (and corresponding changes to BWPs) would not cause a BWP inactivity timer to restart.

Aspects of the disclosure may be implemented to realize one or more potential advantages. For example, by allowing paired uplink and downlink BWPs to have different central frequencies, the UE may be able to access additional uplink and downlink resources within its active uplink and downlink BWPs, which may increase throughput and resource allocation efficiency, while decreasing the quantity of unused resources. Additionally, or alternatively, the configuration of different half-duplex and full-duplex BWP pairings may increase the beam strength and optimize the power control parameters for uplink and downlink communications within active uplink and downlink BWP pairings. These improvements may reduce power consumption in transmitters and receivers, increase spectral efficiency, and result in an improved overall user experience.

Aspects of the disclosure are initially described in the context of wireless communications systems. Aspects of the disclosure are further illustrated by and described with reference to slot configurations supporting both half-duplex and full-duplex communications, a process flow, apparatus diagrams, system diagrams, and flowcharts that relate to BWP configuration for full-duplex communications.

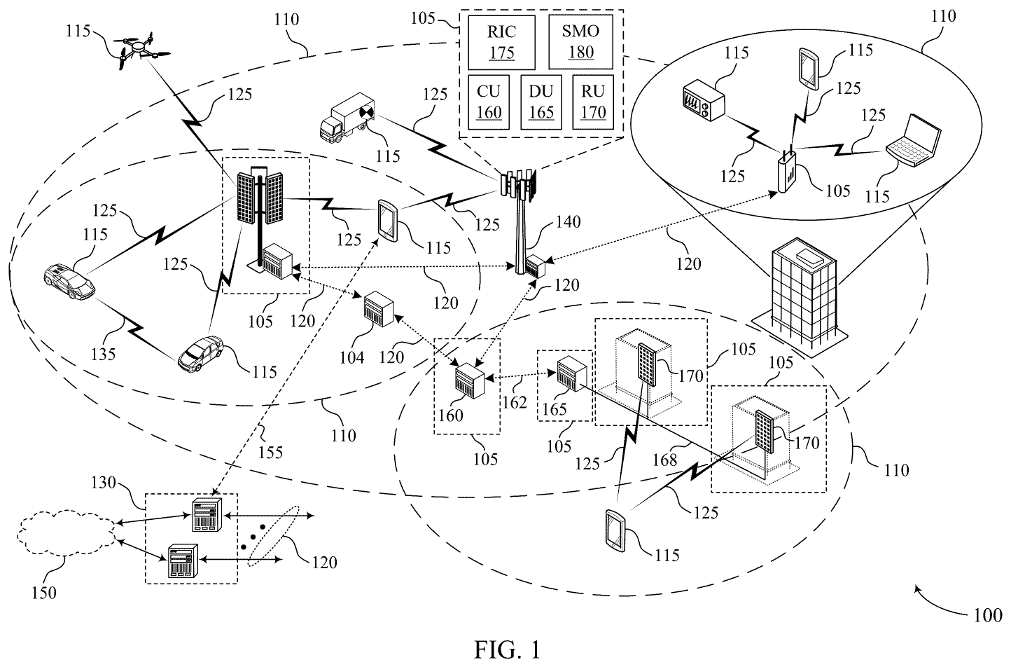

FIG. 1 shows an example of a wireless communications system 100 that supports BWP configuration for full-duplex communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, wireless communications system 100 may support full-duplex operation, for example, where devices (such as UEs 115, network entities 105, or other devices) may support simultaneous uplink and downlink communication, which may increase the spectral efficiency and throughput of communications. One example of full-duplex operation may include in-band full-duplex (IBFD), where a device (such as a network entity 105, a UE 115, or both) may transmit and receive communications on the same time and frequency resource (e.g., the time and frequency resources may be at least partially overlapping). In such IBFD implementations, downlink and uplink resources may share the same IBFD time and frequency resource (or resources), where the downlink and uplink resources at least partially overlap in time, frequency, or both. Another example of full-duplex operation may include subband frequency division duplex (FDD), SBFD, or “flexible duplex” communication. In such FDD communications, a UE 115, a network entity 105, or both, may transmit and receive communications simultaneously (e.g., at the same time) but on different frequency resources. For example, downlink and uplink resources may be separated in the frequency domain (e.g., by a guard band). In some implementations, a network entity 105 may transmit one or more SBFD configurations to a UE 115 to configure the UE 115 with one or more SBFD resource sets for SBFD communications (e.g., for uplink and downlink signals and channels). In some examples, the network entity 105 may send additional dynamic updates for an SBFD configuration, and may support SBFD collision handling and mitigation, SBFD cross-link interference handling, among other performance enhancements for SBFD communications.

In some implementations, the wireless communications system 100 may operate over a system bandwidth or a component carrier (CC) bandwidth, and may partition the system bandwidth into multiple BWPs (e.g., portions of the system bandwidth). A network entity 105 may dynamically assign a UE 115 to operate over one or more indicated BWP, which may include one or more downlink BWPs, one or more uplink BWPs, or a combination thereof. In some aspects, the one or more indicated BWPs may be referred to as “active” BWPs for the UE 115, and the UE 115 may monitor the active BWPs for signaling information from the network entity 105. In some examples, the network entity 105 may assign uplink and downlink BWPs using configuration signaling, including an uplink BWP configuration, a downlink BWP configuration, or both. For example, an uplink BWP configuration may include an uplink BWP identifier (ID), a frequency location of the uplink BWP, other bandwidth information, subcarrier spacing information, cyclic prefix information, among other parameters. Similarly, a downlink BWP configuration may include a downlink BWP ID, a dedicated configuration, a common configuration, a frequency location of the downlink BWP, other bandwidth information, among other parameters.

Some wireless communications systems may support full-duplex communications on a FDD band, where a UE 115 or a network entity 105 may perform simultaneous uplink and downlink communications on uplink and downlink resources spanning different frequencies of the FDD band. The UE 115 may also be configured with one or more BWPs, which include a set of frequencies that the UE 115 may use to perform the uplink and downlink communications. In some FDD deployments, downlink BWPs and uplink BWPs may be unpaired, such that any set of configured downlink BWP and uplink BWP may be active at any time. In some other implementations, such as in TDD deployments, the uplink BWPs and downlink BWPs may be paired, such that when a certain uplink BWP is active, then the corresponding downlink BWP (with the same BWP ID as the uplink BWP) may also be active, with both BWPs sharing a same central frequency.

Maintaining separate BWP configurations in both TDD and FDD deployments, however, may pose challenges for a UE that is capable of full-duplex operations. For example, in TDD deployments, downlink BWPs and uplink BWPs are configured to share a same central frequency, which may lead to a portion of at least one of the BWPs to be outside of a corresponding TDD band during full-duplex operations.

The wireless communications system 100 may implement various techniques to support full-duplex operation for the full-duplex capable UE operating in both FDD and TDD bands. For example, in order to more efficiently allocate resources for paired BWPs, the restriction on paired downlink and uplink BWPs having a same central frequency is relaxed, such that the paired uplink and downlink BWPs may have different central frequencies. In some other examples, the network may provide one or more RRC messages that indicate a table that includes different pairings of downlink and uplink BWPs for half-duplex operation, and corresponding pairings of downlink and uplink BWPs for full-duplex operation, so that the UE 115 can determine which BWPs to use when switching from a half-duplex mode to a full-duplex mode and vice versa. In some cases, the UE 115 may switch between half-duplex and full-duplex BWP pairings based on a switching indication received via DCI or other control signaling.

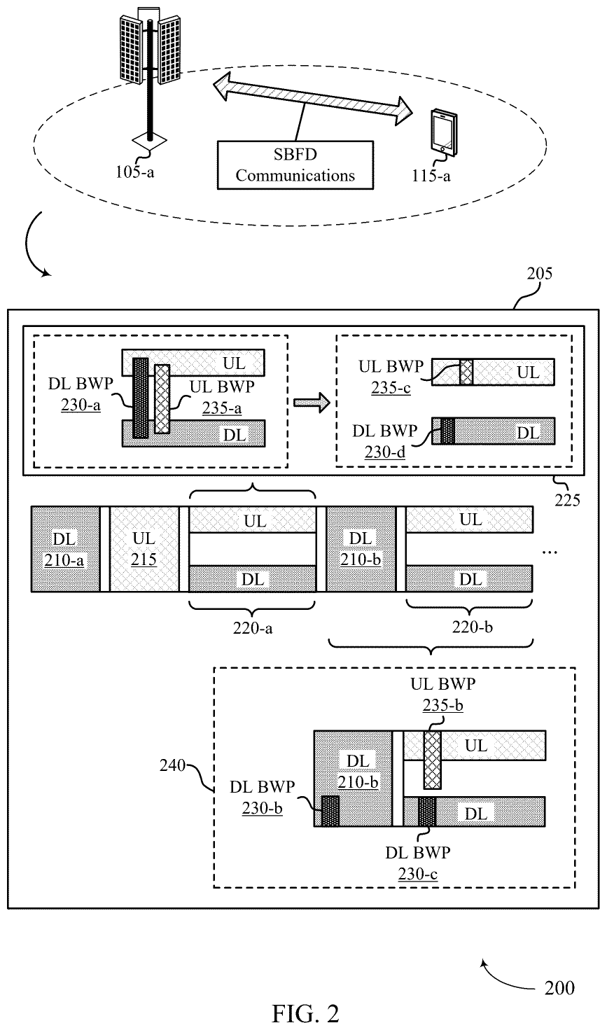

FIG. 2 shows an example of a wireless communications system 200 that supports BWP configuration for full-duplex communications in accordance with one or more aspects of the present disclosure. For example, the wireless communications system 200 illustrates communications between a UE 115-a and a network entity 105-a, each of which may be examples of UEs 115 and network entities 105 described with reference to FIG. 1. In some aspects, the wireless communications system 200 may support full-duplex communications, including SBFD communications, by the UE 115-a, the network entity 105-a, or both.

In some implementations, the network entity 105-a may configure a set of communication resources 205 spanning a plurality of slots, where slot may support either full-duplex operation (e.g., FDD, SBFD) or half-duplex operation (e.g., TDD). For example, the network entity 105-a may configure a first downlink slot 210-a, an uplink slot 215, a first full-duplex slot 220-a, a second downlink slot 210-b, and a second full-duplex slot 220-b, for use by the UE 115-a. The set of communication resources 205 may include a different quantity of uplink slots, downlink slots, and full-duplex slots, and the slot ordering may be different than the ordering illustrated. In addition, the UE 115-a may be configured with one or more uplink and downlink BWPs (or pairs of BWPs) that span at least a portion of the configured slots. For example, if an active downlink BWP of the UE 115-a at least partially overlaps with downlink resources of the first downlink slot 210-a, the second downlink slot 210-b, or either of the downlink bands of the full-duplex slots (e.g., first full-duplex slot 220-a and second full-duplex slot 220-b), and the UE 115-a may receive downlink communications within the active downlink BWP. Additionally, or alternatively, if an active uplink BWP of the UE 115-a at least partially overlaps with uplink resources of the uplink slot 215 or either of the uplink bands of the full-duplex slots (e.g., first full-duplex slot 220-a and second full-duplex slot 220-b), and the UE 115-a may transmit uplink communications within the active uplink BWP.

In some aspects, the UE 115-a may support FDD operation, where the uplink and downlink BWPs are not paired, such that any pair of configured downlink BWP and uplink BWP may be active at any time. For example, if the UE 115-a operates in a first uplink BWP (e.g., BWP 0, or another uplink BWP), the UE 115-a may operate in a same or different corresponding downlink BWP (e.g., BWP 0, or another downlink BWP). In such FDD operation, the central frequency (e.g., a center frequency of the BWP) and bandwidth may be different for uplink and downlink BWPs based on different allocated frequencies. Additionally, or alternatively, the UE 115-a may support TDD operation, where the uplink BWPs and downlink BWPs may be paired together, such that when a first uplink BWP (e.g., uplink BWP 0 or another uplink BWP with index n) is active, then the corresponding downlink BWP (e.g., downlink BWP 0 or another corresponding downlink BWP with index n) may also be active, with both BWPs sharing the same index and the same central frequency. In such TDD operation, the bandwidths may be different for the paired uplink and downlink BWPs, but the central frequency may remain the same.

In some aspects, for example when the UE 115-a supports full-duplex operations, separate BWP configurations in TDD and FDD deployments may pose challenges. For example, in TDD deployments 225, the downlink BWP and uplink BWP have a same central frequency, which may lead to a large portion of at least one of the BWPs to be outside of the corresponding band. For example, the UE 115-a may be allocated an uplink and downlink BWP pair including downlink BWP 230-a and uplink BWP 235-a. In order for both of the BWPs to (at least partially) overlap with the corresponding uplink and downlink bands (e.g., so that downlink BWP 230-a at least partially overlaps with the downlink band and uplink BWP 235-a at least partially overlaps with the uplink band), the central frequency for both BWPs may be placed in the middle of the band. But this placement of the central frequency may allow for a large portion of both BWPs to be unusable, for example, the portion of the downlink BWP 230-a spanning from the edge of the downlink subband to the end of the downlink BWP 230-a may be unusable since that portion does not overlap with the downlink subband. Similarly, the portion of the uplink BWP 235-a spanning from the edge of the uplink subband to the end of the uplink BWP 235-a may be unusable since that portion does not overlap with the uplink subband.

Additionally, or alternatively, in In FDD deployments 240, the UE 115-a may perform frequent switching between TDD slots (e.g., the second downlink slot 210-b) and full-duplex slots (e.g., the second full-duplex slot 220-b, SBFD slots), which may cause the UE 115-a to perform frequent BWP switching. For example, the UE 115-a may receive downlink communications in the second downlink slot 210-b using the downlink BWP 230-b, and then may switch to a full-duplex mode in the second full-duplex slot 220-b. The switch to the full-duplex mode may also cause the UE 115-a to switch to use of uplink BWP 235-b and downlink BWP 230-c. The frequent switching between TDD and full-duplex slots may pose challenges for the UE 115-a in terms of power consumption, timing and resource monitoring, among other possible challenges. Additionally, or alternatively, frequent switching between different slot types may lead to RRC parameter duplication (e.g., sounding reference signal (SRS) parameter duplication, semi-persistent scheduling (SPS) duplication), where RRC parameters are duplicated for downlink and uplink slots and downlink and uplink portions of a full-duplex slot. Further duplication of other parameters and configurations (e.g., beam configurations, power control configurations) may also occur.

The wireless communications system 200 may implement various different techniques to support efficient full-duplex operation for a UE operating in both FDD and TDD bands. For example, to increase the resource allocation and utilization efficiency for the UE 115-a operating in a full-duplex slot (and operating in a TDD band), the network may relax a restriction on downlink and uplink BWPs (having same ID) having a same central frequency, so that the uplink and downlink BWPs with the same ID can have different central frequencies. For example, in TDD deployments 225, the uplink BWP 235-c and the downlink BWP 230-d may have different central frequencies. In some other examples, the network entity 105-a may provide (via RRC messaging) a table that includes different pairings of downlink and uplink BWPs for half-duplex operation, and corresponding pairings of downlink and uplink BWPs for full-duplex operation, so that the UE 115-a may determine which BWPs to use when switching from a half-duplex mode to a full-duplex mode. In some examples, the pairing may be indicated by a lookup table, and in some other examples the pairing may be included within an information element for a corresponding uplink or downlink BWP.

Additionally, or alternatively, the UE 115-a may be configured with the lookup table, and may be triggered to switch between half-duplex and full-duplex BWP pairings via one or more DCI messages, so that if the UE 115-a receives a trigger to switch from a first half-duplex pairing to a second half-duplex paring, the UE 115 may switch to a corresponding full-duplex pairing based on the lookup table. In addition, to support efficient switching between half-duplex and full-duplex slots, the UE 115-a may refrain from restarting a BWP inactivity timer based on the switching between half-duplex slots and full-duplex slots (and corresponding changes to BWPs).

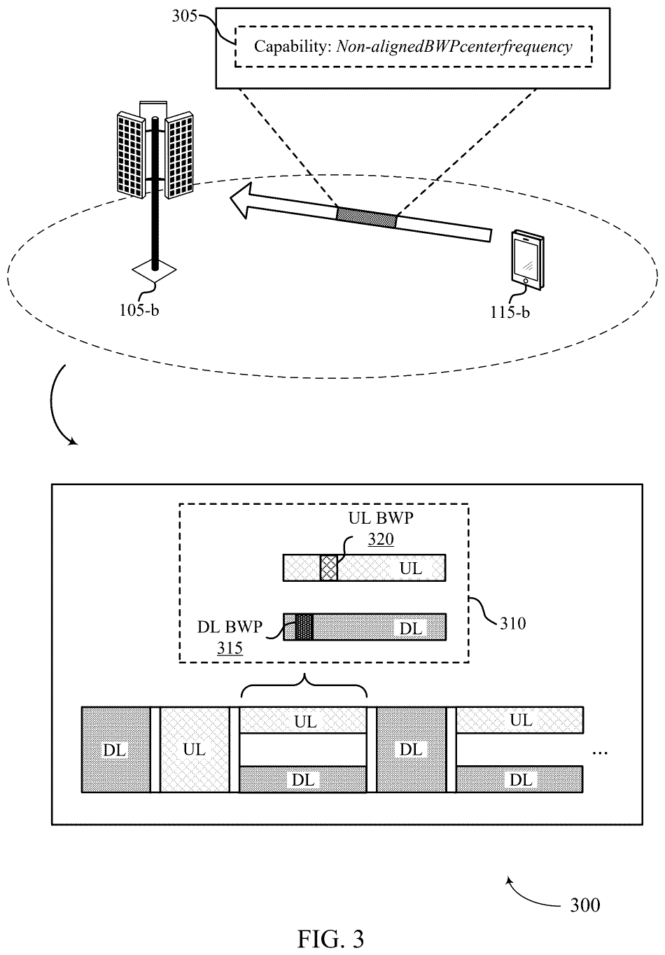

FIG. 3 shows an example of a wireless communications system 300 that supports BWP configuration for full-duplex communications in accordance with one or more aspects of the present disclosure. For example, the wireless communications system 300 illustrates communications between a UE 115-b and a network entity 105-b, each of which may be examples of UEs 115 and network entities 105 described with reference to FIGS. 1 and 2. In some aspects, the wireless communications system 300 may support full-duplex communications, including SBFD communications, by the UE 115-b, the network entity 105-b, or both.

In some implementations, the network entity 105-b may configure a set of communication resources spanning a plurality of slots, where slot may support either full-duplex operation (e.g., FDD, SBFD) or half-duplex operation (e.g., TDD). For example, the network entity 105-a may configure one or more downlink slots, one or more uplink slots, and one or more full-duplex or SBFD slots (including full-duplex slot 310) for use by the UE 115-b. The set of communications resources may include a different quantity of uplink slots, downlink slots, and full-duplex slots, and the slot ordering may be different than the ordering illustrated. In addition, the UE 115-a may be configured with one or more uplink and downlink BWPs (or pairs of BWPs) that span at least a portion of the configured slots. For example, the downlink BWP 315 of the UE 115-b may at least partially overlap with downlink resources of the full-duplex slot 310, and the UE 115-b may receive downlink communications within the downlink BWP 315. In addition, the uplink BWP 320 of the UE 115-b may at least partially overlap with uplink resources of the uplink band of the full-duplex slot 310, and the UE 115-b may transmit uplink communications within the uplink BWP 320.

The wireless communications system 300 may implement various different techniques to support efficient full-duplex operation for the UE 115-b, which may switch between FDD and TDD-configured slots. For example, to increase the resource allocation efficiency in full-duplex slots, the network entity 105-b may relax a restriction on downlink and uplink BWPs (e.g., a pair of downlink and uplink BWPs having a same ID) having a same central frequency, so that the uplink and downlink BWPs with the same ID can have different central frequencies.

For example, for unpaired spectrum operation, the UE 115-b may not expect to receive a configuration (e.g., from the network entity 105-b or one or more other network entities) where the center frequency for a downlink BWP (such as downlink BWP 315) is different than the center frequency for an uplink BWP (such as uplink BWP 320) when the BWP ID (e.g., BWP-id) of the downlink BWP is same as the BWP ID of the uplink BWP except when the UE indicates a capability non-alignedBWPcenterfrequency which may be reported by the UE 115-b. In such examples, the UE 115-b may transmit one or more messages to the network entity 105-b, where the one or more messages include an indication of a non-alignedBWPcenterfrequency capability of the UE to support uplink and downlink BWPs having non-aligned center frequencies within a full-duplex slot. For example, the network entity 105-b may configure the downlink BWP 315 and the uplink BWP 320 to have different center frequencies, and the UE 115-b may transmit communications on the uplink BWP 320 of the uplink band or may receive communications on the downlink BWP 315 of the downlink band.

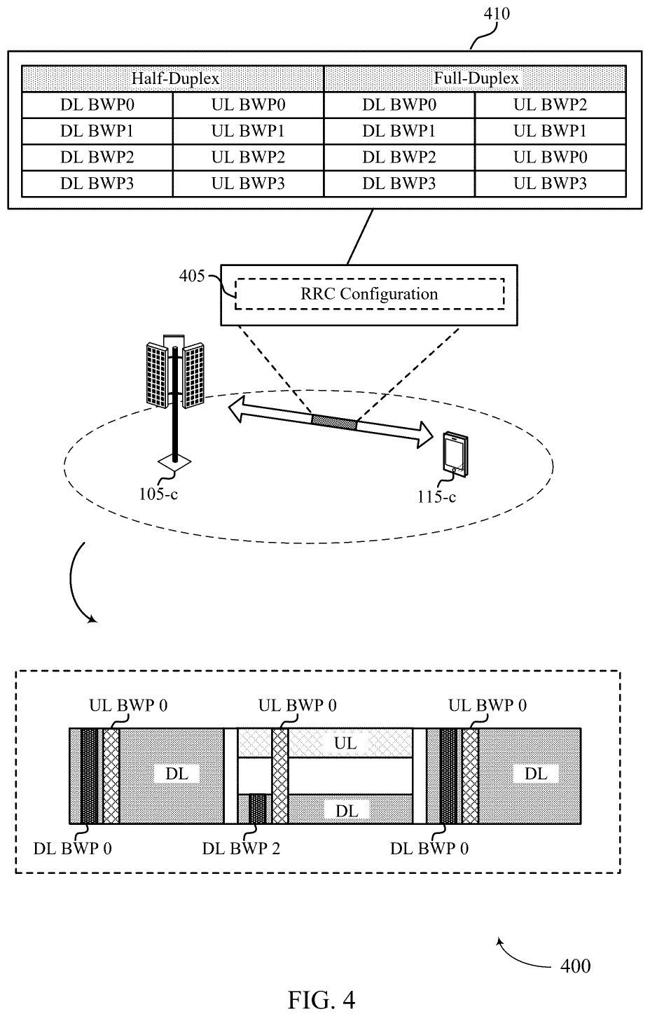

FIG. 4 shows an example of a wireless communications system 400 that supports BWP configuration for full-duplex communications in accordance with one or more aspects of the present disclosure. For example, the wireless communications system 400 illustrates communications between a UE 115-c and a network entity 105-c, each of which may be examples of UEs 115 and network entities 105 described with reference to FIGS. 1, 2, and 3. In some aspects, the wireless communications system 400 may support full-duplex communications, including SBFD communications, by the UE 115-c, the network entity 105-c, or both.

The wireless communications system 400 may implement various different techniques to support efficient full-duplex operation for the UE 115-c. For example, the UE 115-c may support semi-static switching of BWP pairings (e.g., uplink BWP pairings and downlink BWP pairings) based on slot type (e.g., whether the UE 115-c is operating in a half-duplex slot or a full-duplex slot) and UE operation. In such examples, the network entity 105-c may output RRC signaling including an RRC configuration 405 that includes a BWP pairing table. The UE 115-c may receive the indication of the BWP pairing table 410 via the RRC signaling, and may use the BWP pairing table 410 to determine which downlink and uplink BWP pairs to use for different half-duplex and full-duplex slots. An example BWP pairing table 410 is illustrated below:

| | |
|---|---|
| Half-Duplex | Full-Duplex |

| | | | |
|---|---|---|---|
| DL BWP0 | UL BWP0 | DL BWP0 | UL BWP2 |
| DL BWP1 | UL BWP1 | DL BWP1 | UL BWP1 |
| DL BWP2 | UL BWP2 | DL BWP2 | UL BWP0 |
| DL BWP3 | UL BWP3 | DL BWP3 | UL BWP3 |

For half-duplex operations, the UE 115-c BWPs may be paired such that BWPs having the same index may be paired together (e.g., uplink BWP0 may be paired with corresponding downlink BWP0, uplink BWP1 may be paired with corresponding downlink BWP1, and so on). For full-duplex operation, however the network entity 105-c may configure different BWP pairings. For example, a downlink BWP0 may be paired with the uplink BWP2, the downlink BWP1 may be paired with uplink BWP1, the downlink BWP2 may be paired with uplink BWP0, and the downlink BWP3 may be paired with the uplink BWP3, although other pairings are possible. In some cases, the BWP parings may be based on an optimization of power control parameters, beam quality, or other parameters determined for the UE 115-c for a given slot.

In some implementations, the UE 115-c may be configured with a first uplink and downlink BWP pairing (e.g., downlink BWP0 and uplink BWP0) for a first downlink slot, and may receive downlink communications using the allocated downlink BWP. Then the UE 115-c may switch to a full-duplex mode, and may determine which BWP pairing to use based on the BWP pairing table 410, for example, a BWP paring that includes downlink BWP2 and uplink BWP0. The UE 115-c may then transmit uplink communications using the uplink BWP0 and may receive downlink communications using the downlink BWP2. The UE 115-c may then switch back to a half-duplex mode in a following downlink slot, and may use an uplink and downlink BWP pairing (e.g., downlink BWP0 and uplink BWP0) to receive downlink communications using the allocated downlink BWP.

In some implementations, after receiving the RRC configuration 405, the UE 115-c may receive additional control signaling such as one or more DCI which indicates a switch in the half-duplex BWP pairing, and the UE 115-c may determine a corresponding full-duplex BWP pairing based on the switch in the half-duplex pairing. For example, the UE 115-c may receive a DCI which indicates a switch from downlink BWP0 and uplink BWP0 to downlink BWP2 and uplink BWP2. The UE 115-c may then determine a corresponding switch in full-duplex mode based on the RRC configuration 405 and the BWP pairing table 410. For example, a switch from BWP0 and uplink BWP0 to downlink BWP2 and uplink BWP2 in half-duplex may correspond to a switch from downlink BWP0 and uplink BWP2 to downlink BWP2 and uplink BWP0, based on the corresponding pairings in the BWP pairing table 410.

Additionally, or alternatively, the RRC configuration 405 may include one or more downlink and uplink BWP configurations (e.g., BWP-Downlink and BWP-Uplink). In some examples, the BWP-Downlink configuration may include an information element that has one or more pointers to an associated full-duplex BWP pairing for full-duplex slots, and the BWP-Uplink configuration may include an information element that has one or more pointers to an associated full-duplex BWP pairing for full-duplex slots.

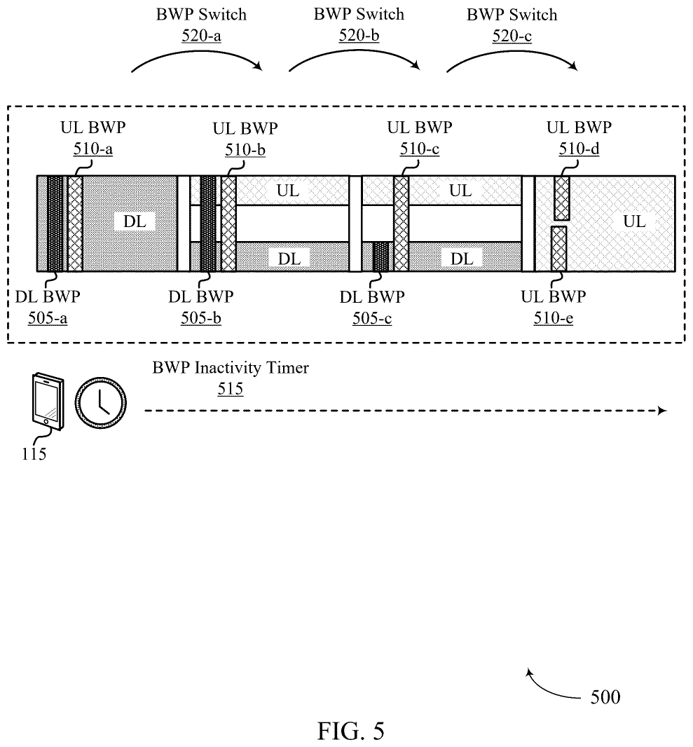

FIG. 5 shows an example of a slot configuration 500 that supports BWP configuration for full-duplex communications in accordance with one or more aspects of the present disclosure. For example, the slot configuration 500 be implemented at or by a network entity 105 and a UE 115, each of which may be examples of UEs 115 and network entities 105 described with reference to FIGS. 1, 2, 3, and 4. In some aspects, the slot configuration 500 may support full-duplex communications, including SBFD communications, by the UE 115, a network entity 105, or both.

The slot configuration 500 may support efficient full-duplex operation for the UE 115. For example, the UE 115 may be configured with various sets of BWP pairs for communications within different half-duplex and full-duplex slot. In a first downlink slot, the UE 115 may be configured with a first downlink BWP 505-a and a first uplink BWP 510-a. In a first full-duplex slot, the UE 115 may be configured with a second downlink BWP 505-b and a second uplink BWP 510-b. In a second full-duplex slot (that follows the first full-duplex slot), the UE 115 may be configured with a third downlink BWP 505-c and a third uplink BWP 510-c (which may be same as or different from the second downlink BWP 505-b and the second uplink BWP 510-b in the first full-duplex slot). In a first uplink slot, the UE 115 may be configured with a fourth uplink BWP 510-d and a fifth uplink BWP 510-c.

In some implementations, the UE 115 may initiate a BWP inactivity timer 515, where the expiry of the timer prompts the UE 115 to switch from an active BWP to a default BWP if the UE 115 does not detect or initiate communications. In some examples, however, switching between active BWPs may trigger a re-start of the BWP inactivity timer 515. In order to support more frequent switching of active BWPs (e.g., between half-duplex slots and full-duplex slots), the UE 115 may be configured to refrain from restarting the BWP inactivity timer 515 based on switching of slot type, such as switching between half-duplex slots and full-duplex slots (or vice versa). Since switching between slot types does not impact the activity or non-activity of the active BWP, the switch in active BWPs between different slots may not have an impact on the BWP inactivity timer 515.

For example, the UE 115 may initiate the BWP inactivity timer 515 at the beginning of the first downlink slot, where the UE 115 may begin monitoring the first downlink BWP 505-a. Then, the UE 115 may switch from the first downlink slot to the first full-duplex slot, and may undergo a first BWP switch 520-a from the first downlink BWP 505-a to monitoring the second downlink BWP 505-b and the second uplink BWP 510-b. The UE 115 may keep the BWP inactivity timer running (e.g., the UE 115 may not restart the BWP inactivity timer) after the first BWP switch 520-a. The UE 115 may then switch from the first full-duplex slot to the second full-duplex slot, and may undergo a second BWP switch 520-b from the second downlink BWP 505-b and the second uplink BWP 510-b to the third downlink BWP 505-c and the third uplink BWP 510-c. The UE 115 may keep the BWP inactivity timer running (e.g., the UE 115 may not restart the BWP inactivity timer) after the second BWP switch 520-b. The UE 115 may then switch from the second full-duplex slot to the first uplink slot, and may undergo a third BWP switch 520-c from the third downlink BWP 505-c and the third uplink BWP 510-c to the fourth uplink BWP 510-d and the fifth uplink BWP 510-e. The UE 115 may keep the BWP inactivity timer running (e.g., the UE 115 may not restart the BWP inactivity timer) after the third BWP switch 520-c.

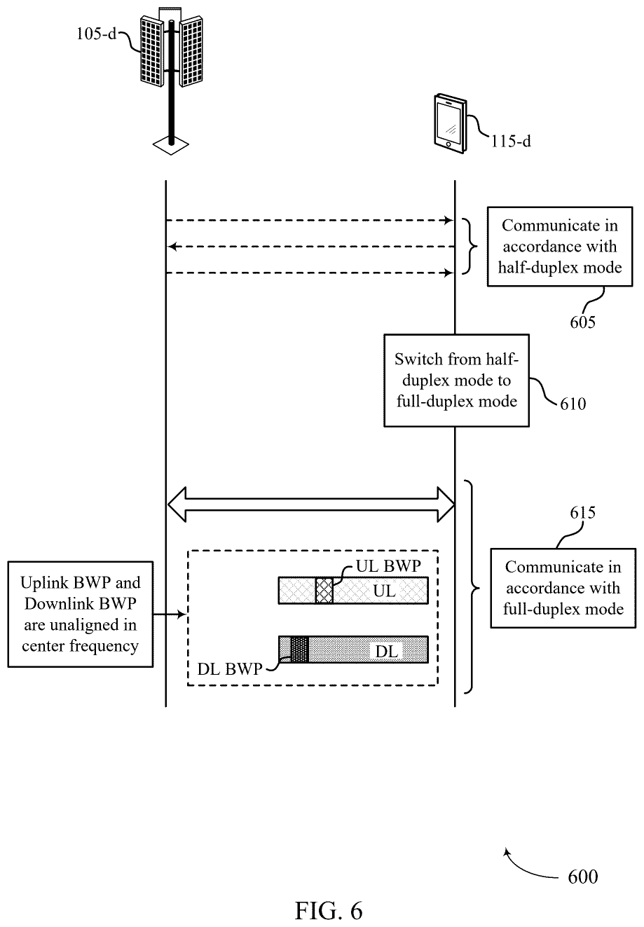

FIG. 6 shows an example of a process flow 600 that supports BWP configuration for full-duplex communications in accordance with one or more aspects of the present disclosure. The process flow 600 may implement or be implemented by aspects of the wireless communications system 100, the wireless communications system 200, the wireless communications system 300, or the wireless communications system 400. The process flow 600 may include a network entity 105-d and a UE 115-d, each of which may be examples of network entities and UEs described herein. In the following description of process flow 600, the operations may be performed in a different order than the order shown, or other operations may be added or removed from the process flow 600. For example, some operations may also be left out of process flow 600, may be performed in different orders or at different times, or other operations may be added to process flow 600. Although communications of the process flow 600 are shown occurring between a network entity 105-d and a UE 115-d, some aspects of some operations may also be performed by one or more other wireless devices, network devices, or network functions.

At 605, the UE 115-d may communicate one or more first messages (e.g., uplink messages or downlink messages) in accordance with a half-duplex mode of operation in a TDD band.

At 610, the UE 115-d may switch from the half-duplex mode of operation to a full-duplex mode of operation in the TDD band.

At 615, the UE 115-d may communicate one or more second messages in accordance with the full-duplex mode of operation in an uplink BWP and a downlink BWP of the TDD band (e.g., the uplink BWP and the downlink BWP may be associated with a same BWP ID), where the uplink BWP and the downlink BWP may be unaligned in center frequency for the full-duplex mode of operation.

In some aspects, the UE 115-d may transmit an indication of a capability of the UE 115-d to support the full-duplex mode of operation based on the uplink BWP and the downlink BWP being unaligned in center frequency, and may communicate the one or more second messages based on the UE capability.

In some implementations, the UE 115-d may receive, from the network entity 105-d, one or more RRC messages that include an RRC configuration that indicates a first set of BWP pairings associated with the half-duplex mode of operation and a second set of BWP pairings associated with the full-duplex mode of operation. In some examples, the first set of BWP pairings and the second set of BWP pairings may be included in a lookup table as part of the one or more RRC messages. The UE 115-d may then communicate the one or more second messages in accordance with a first BWP pairing of the second set of BWP pairings associated with the full-duplex mode of operation, where the first BWP pairing includes the uplink BWP and the downlink BWP.

In some examples, the UE 115-d may switch from the first BWP pairing of the second set of BWP pairings to a second BWP pairing of the first set of BWP pairings based on a corresponding switch from a full-duplex slot to a half-duplex slot. In some examples, the first set of BWP pairings and the second set of BWP pairings are associated with different respective communication beams, different respective power control parameters, or both.

In some implementations, the UE 115-d may receive an RRC configuration message that includes a first information element associated with the uplink BWP, where the first information element includes a BWP ID of a respective downlink BWP that corresponds to the uplink BWP, where the uplink BWP and the respective downlink BWP are a BWP pairing that the UE 115-d may use to communicate in accordance with the full-duplex mode of operation. Additionally, or alternatively, the UE may receive a first information element associated with the downlink BWP, where the first information element includes an BWP ID of a respective uplink BWP that corresponds to the downlink BWP, where the downlink BWP and the respective uplink BWP are a BWP pairing that the UE 115-d may use to communicate in accordance with the full-duplex mode of operation.

In some implementations, the UE 115-d may receive one or more RRC messages that include an RRC configuration that indicates a first set of BWP pairings associated with the half-duplex mode of operation and a corresponding second set of BWP pairings associated with the full-duplex mode of operation, The UE 115-d may then receive, via a DCI message, instruction to switch from a first BWP pairing to a second BWP pairing of the first set of BWP pairings. Then, based on the switching instructed by the DCI message, the UE 115-d may switch from a first corresponding BWP pairing to a second corresponding BWP pairing of the corresponding second set of BWP pairings.

In some implementations, the UE 115-d may receive, via an RRC message, a parameter that activates a timer (e.g., a BWP inactivity timer) that is associated with switching between a default BWP and one or more active BWPs, and the UE 115-d may switch from a first active BWP pairing of a half-duplex slot to a second active BWP pairing of a full-duplex slot, where the timer remains active after the switching. For example, the UE 115-d may refrain from restarting the timer based on switching a slot type from the half-duplex slot to the full-duplex slot.

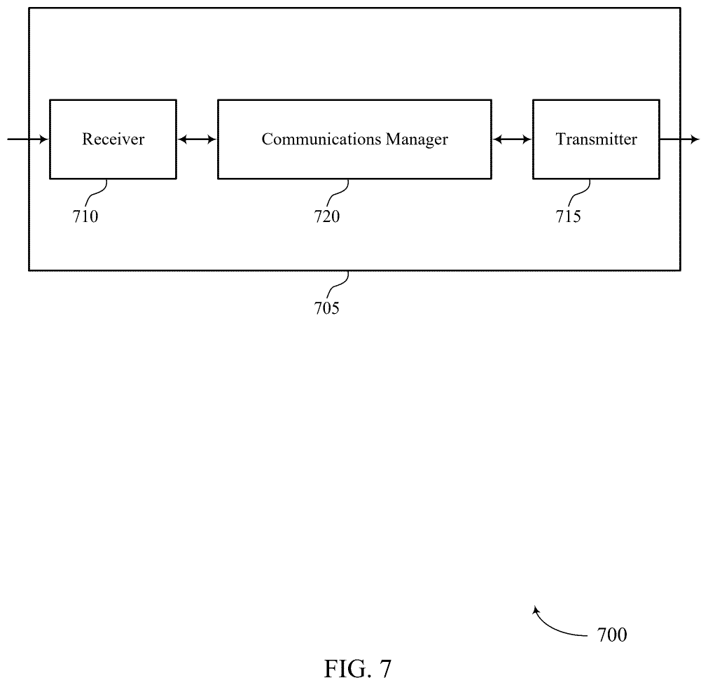

FIG. 7 shows a block diagram 700 of a device 705 that supports BWP configuration for full-duplex communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to BWP configuration for full-duplex communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to BWP configuration for full-duplex communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of BWP configuration for full-duplex communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for communicating one or more first messages in accordance with a half-duplex mode of operation in a TDD band. The communications manager 720 is capable of, configured to, or operable to support a means for switching from the half-duplex mode of operation to a full-duplex mode of operation in the TDD band. The communications manager 720 is capable of, configured to, or operable to support a means for communicating one or more second messages in accordance with the full-duplex mode of operation in an uplink BWP and a downlink BWP of the TDD band, where the uplink BWP and the downlink BWP are unaligned in center frequency for the full-duplex mode of operation.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, more efficient utilization of communication resources, reduced quantity of unused frequency resources, more efficient switching between half-duplex and full-duplex modes, among other potential advantages.

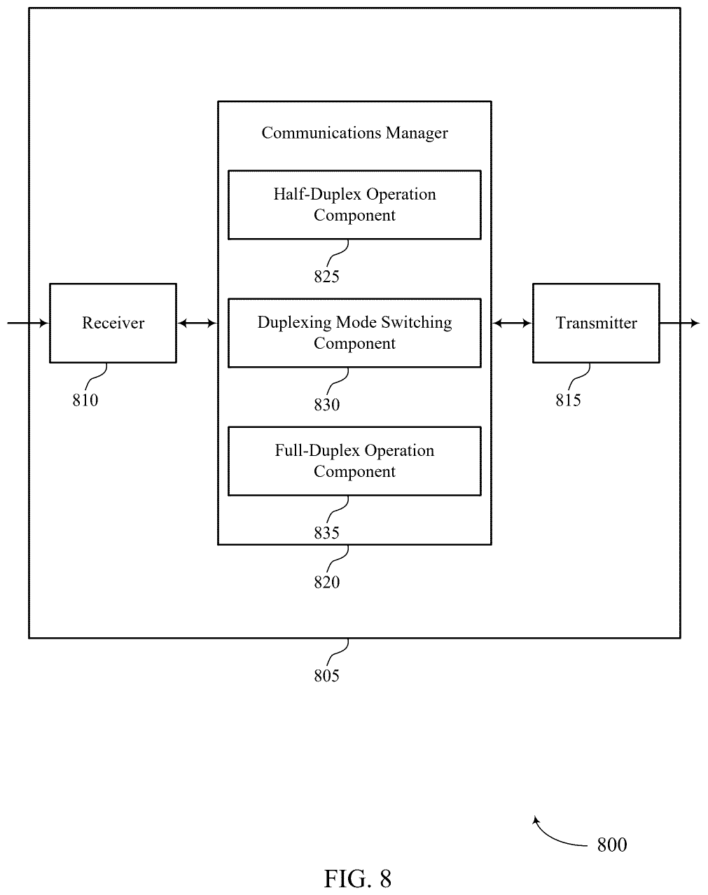

FIG. 8 shows a block diagram 800 of a device 805 that supports BWP configuration for full-duplex communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to BWP configuration for full-duplex communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to BWP configuration for full-duplex communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of BWP configuration for full-duplex communications as described herein. For example, the communications manager 820 may include a half-duplex operation component 825, a duplexing mode switching component 830, a full-duplex operation component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The half-duplex operation component 825 is capable of, configured to, or operable to support a means for communicating one or more first messages in accordance with a half-duplex mode of operation in a TDD band. The duplexing mode switching component 830 is capable of, configured to, or operable to support a means for switching from the half-duplex mode of operation to a full-duplex mode of operation in the TDD band. The full-duplex operation component 835 is capable of, configured to, or operable to support a means for communicating one or more second messages in accordance with the full-duplex mode of operation in an uplink BWP and a downlink BWP of the TDD band, where the uplink BWP and the downlink BWP are unaligned in center frequency for the full-duplex mode of operation.

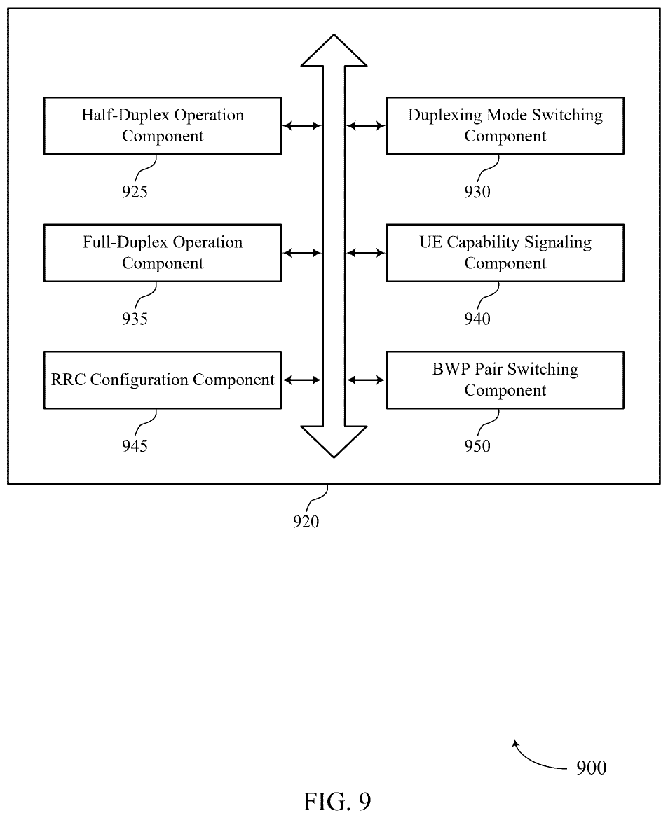

FIG. 9 shows a block diagram 900 of a communications manager 920 that supports BWP configuration for full-duplex communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of BWP configuration for full-duplex communications as described herein. For example, the communications manager 920 may include a half-duplex operation component 925, a duplexing mode switching component 930, a full-duplex operation component 935, a UE capability signaling component 940, an RRC configuration component 945, a BWP pair switching component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The half-duplex operation component 925 is capable of, configured to, or operable to support a means for communicating one or more first messages in accordance with a half-duplex mode of operation in a TDD band. The duplexing mode switching component 930 is capable of, configured to, or operable to support a means for switching from the half-duplex mode of operation to a full-duplex mode of operation in the TDD band. The full-duplex operation component 935 is capable of, configured to, or operable to support a means for communicating one or more second messages in accordance with the full-duplex mode of operation in an uplink BWP and a downlink BWP of the TDD band, where the uplink BWP and the downlink BWP are unaligned in center frequency for the full-duplex mode of operation.

In some examples, the UE capability signaling component 940 is capable of, configured to, or operable to support a means for transmitting an indication of a capability of the UE to support the full-duplex mode of operation based on the uplink BWP and the downlink BWP being unaligned in center frequency. In some examples, the uplink BWP and the downlink BWP are associated with a same BWP identifier.

In some examples, to support communicating the one or more second messages, the RRC configuration component 945 is capable of, configured to, or operable to support a means for receiving one or more RRC messages that include an RRC configuration that indicates a first set of multiple BWP pairings associated with the half-duplex mode of operation and a second set of multiple BWP pairings associated with the full-duplex mode of operation. In some examples, to support communicating the one or more second messages, the full-duplex operation component 935 is capable of, configured to, or operable to support a means for communicating the one or more second messages in accordance with a first BWP pairing of the second set of multiple BWP pairings associated with the full-duplex mode of operation, where the first BWP pairing includes the uplink BWP and the downlink BWP.

In some examples, the first set of multiple BWP pairings and the second set of multiple BWP pairings are included in a lookup table as part of the one or more RRC messages. In some examples, the BWP pair switching component 950 is capable of, configured to, or operable to support a means for switching from the first BWP pairing of the second set of multiple BWP pairings to a second BWP pairing of the first set of multiple BWP pairings based on a corresponding switch from a full-duplex slot to a half-duplex slot.

In some examples, the first set of multiple BWP pairings and the second set of multiple BWP pairings are associated with different respective communication beams, different respective power control parameters, or both.

In some examples, the RRC configuration component 945 is capable of, configured to, or operable to support a means for receiving, via an RRC configuration message, a first information element associated with the uplink BWP, where the first information element includes an identifier of a respective downlink BWP that corresponds to the uplink BWP, where the uplink BWP and the respective downlink BWP include a BWP pairing to communicate in accordance with the full-duplex mode of operation.

In some examples, the RRC configuration component 945 is capable of, configured to, or operable to support a means for receiving, via an RRC configuration message, a first information element associated with the downlink BWP, where the first information element includes an identifier of a respective uplink BWP that corresponds to the downlink BWP, where the downlink BWP and the respective uplink BWP include a BWP pairing to communicate in accordance with the full-duplex mode of operation.

In some examples, the RRC configuration component 945 is capable of, configured to, or operable to support a means for receiving one or more RRC messages that include an RRC configuration that indicates a first set of multiple BWP pairings associated with the half-duplex mode of operation and a corresponding second set of multiple BWP pairings associated with the full-duplex mode of operation. In some examples, the BWP pair switching component 950 is capable of, configured to, or operable to support a means for receiving, via a DCI message, instruction to switch from a first BWP pairing to a second BWP pairing of the first set of multiple BWP pairings. In some examples, the BWP pair switching component 950 is capable of, configured to, or operable to support a means for switching from a first corresponding BWP pairing to a second corresponding BWP pairing of the corresponding second set of multiple BWP pairings based on the DCI message.

In some examples, the RRC configuration component 945 is capable of, configured to, or operable to support a means for receiving, via an RRC message, a parameter that activates a timer that is associated with switching between a default BWP and one or more active BWPs. In some examples, the duplexing mode switching component 930 is capable of, configured to, or operable to support a means for switching from a first active BWP pairing of a half-duplex slot to a second active BWP pairing of a full-duplex slot, where the timer remains active after the switching. In some examples, the timer includes a BWP inactivity timer. In some examples, to support timer remaining active, the duplexing mode switching component 930 is capable of, configured to, or operable to support a means for refraining from restarting the timer based on switching a slot type from the half-duplex slot to the full-duplex slot.

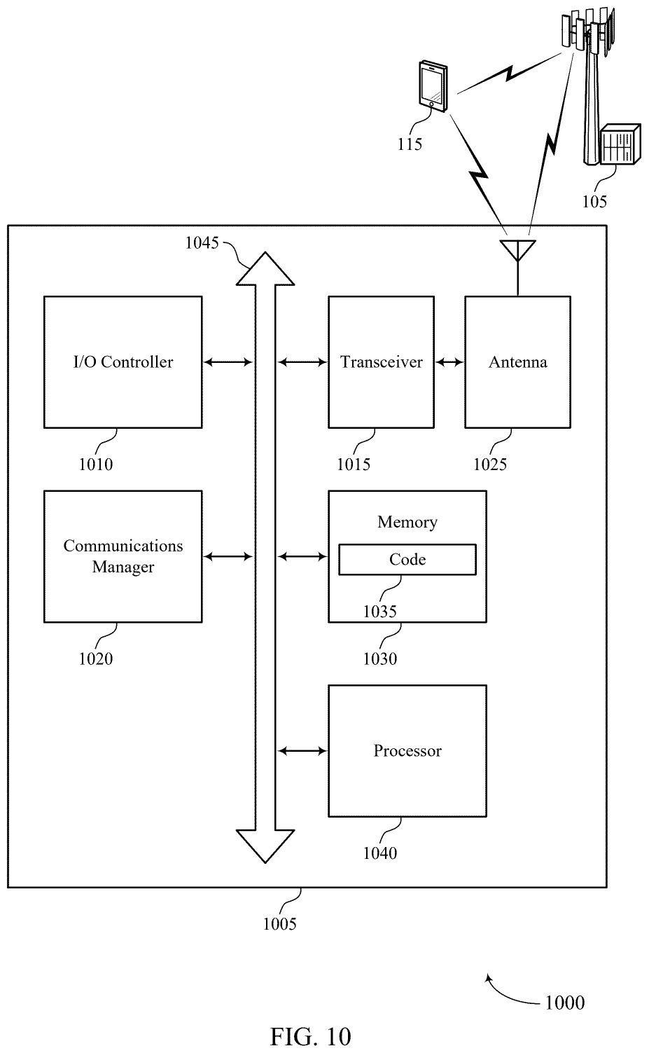

FIG. 10 shows a diagram of a system 1000 including a device 1005 that supports BWP configuration for full-duplex communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting BWP configuration for full-duplex communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for communicating one or more first messages in accordance with a half-duplex mode of operation in a TDD band. The communications manager 1020 is capable of, configured to, or operable to support a means for switching from the half-duplex mode of operation to a full-duplex mode of operation in the TDD band. The communications manager 1020 is capable of, configured to, or operable to support a means for communicating one or more second messages in accordance with the full-duplex mode of operation in an uplink BWP and a downlink BWP of the TDD band, where the uplink BWP and the downlink BWP are unaligned in center frequency for the full-duplex mode of operation.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, increased throughput, reduced quantity of unused frequency resources, more efficient switching between half-duplex and full-duplex modes of the UE, more efficient use of BWP resources, among other potential advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of BWP configuration for full-duplex communications as described herein, or the at least one processor 1040 and the at least one memory 1030 may be otherwise configured to, individually or collectively, perform or support such operations.

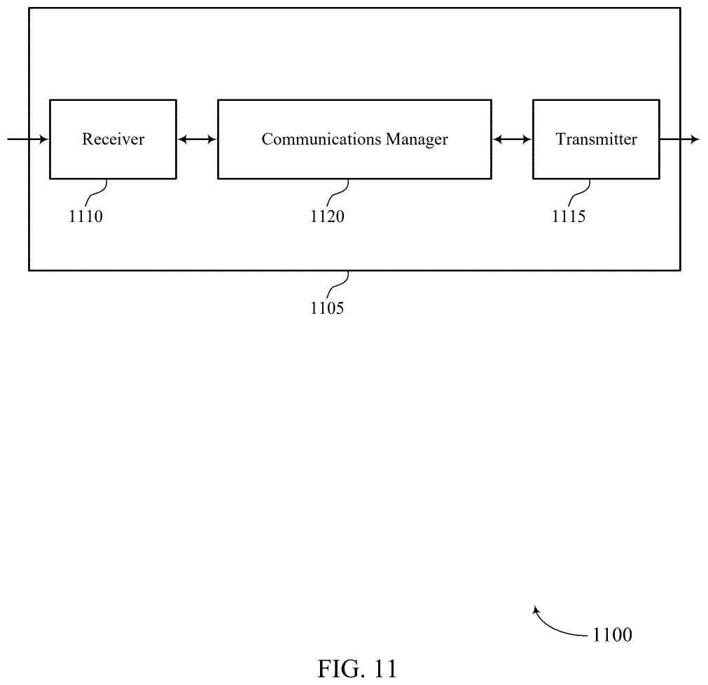

FIG. 11 shows a block diagram 1100 of a device 1105 that supports BWP configuration for full-duplex communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of BWP configuration for full-duplex communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting an indication of a BWP configuration to communicate in a TDD band including at least an uplink BWP and a downlink BWP that are unaligned in center frequency. The communications manager 1120 is capable of, configured to, or operable to support a means for obtaining one or more first messages in a full-duplex mode of operation in the uplink BWP and the downlink BWP of the TDD band, where the uplink BWP and the downlink BWP are unaligned in center frequency in accordance with the BWP configuration.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, more efficient utilization of communication resources, reduced quantity of unused frequency resources, more efficient switching between half-duplex and full-duplex modes, among other potential advantages.

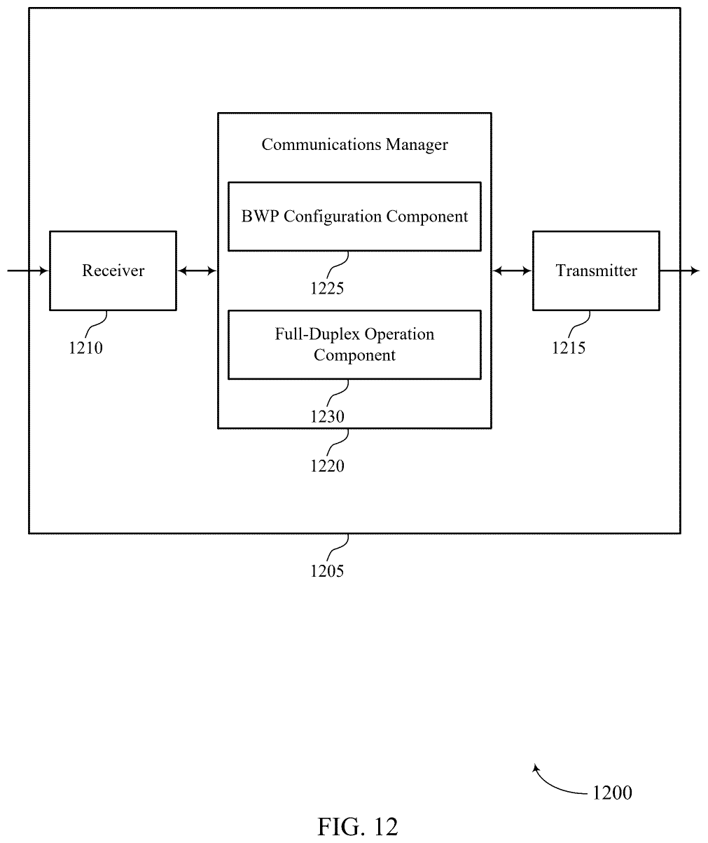

FIG. 12 shows a block diagram 1200 of a device 1205 that supports BWP configuration for full-duplex communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of BWP configuration for full-duplex communications as described herein. For example, the communications manager 1220 may include a BWP configuration component 1225 a full-duplex operation component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The BWP configuration component 1225 is capable of, configured to, or operable to support a means for outputting an indication of a BWP configuration to communicate in a TDD band including at least an uplink BWP and a downlink BWP that are unaligned in center frequency. The full-duplex operation component 1230 is capable of, configured to, or operable to support a means for obtaining one or more first messages in a full-duplex mode of operation in the uplink BWP and the downlink BWP of the TDD band, where the uplink BWP and the downlink BWP are unaligned in center frequency in accordance with the BWP configuration.

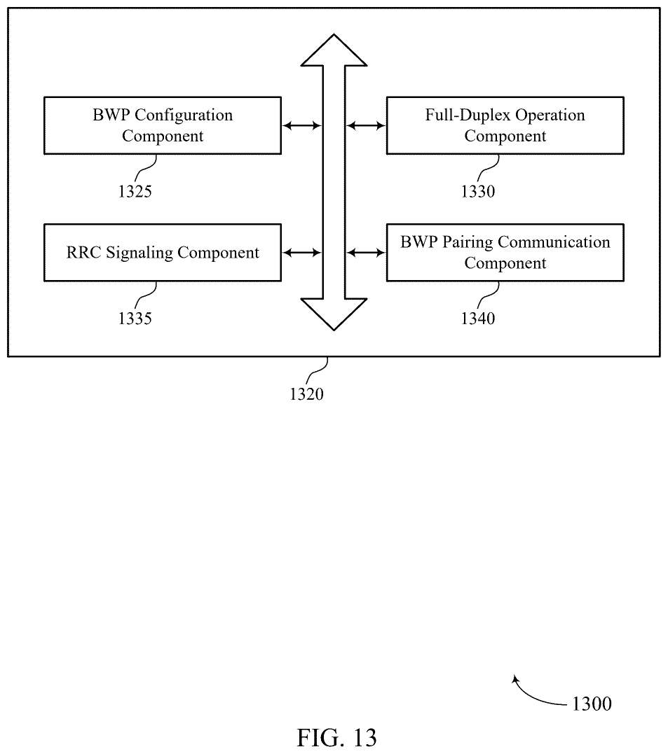

FIG. 13 shows a block diagram 1300 of a communications manager 1320 that supports BWP configuration for full-duplex communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of BWP configuration for full-duplex communications as described herein. For example, the communications manager 1320 may include a BWP configuration component 1325, a full-duplex operation component 1330, an RRC signaling component 1335, a BWP pairing communication component 1340, or any combination thereof.

Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The BWP configuration component 1325 is capable of, configured to, or operable to support a means for outputting an indication of a BWP configuration to communicate in a TDD band including at least an uplink BWP and a downlink BWP that are unaligned in center frequency. The full-duplex operation component 1330 is capable of, configured to, or operable to support a means for obtaining one or more first messages in a full-duplex mode of operation in the uplink BWP and the downlink BWP of the TDD band, where the uplink BWP and the downlink BWP are unaligned in center frequency in accordance with the BWP configuration.

In some examples, the BWP configuration component 1325 is capable of, configured to, or operable to support a means for obtaining an indication of a capability of a UE to support the full-duplex mode of operation based on the uplink BWP and the downlink BWP being unaligned in center frequency, where the uplink BWP and the downlink BWP are associated with a same BWP identifier.

In some examples, to support communicating the one or more first messages, the RRC signaling component 1335 is capable of, configured to, or operable to support a means for outputting one or more RRC messages that include an RRC configuration that indicates a lookup table including a first set of multiple BWP pairings associated with a half-duplex mode of operation and a second set of multiple BWP pairings associated with the full-duplex mode of operation. In some examples, to support communicating the one or more first messages, the BWP pairing communication component 1340 is capable of, configured to, or operable to support a means for obtaining the one or more first messages in accordance with a first BWP pairing of the second set of multiple BWP pairings associated with the full-duplex mode of operation, where the first BWP pairing includes the uplink BWP and the downlink BWP.

In some examples, the RRC signaling component 1335 is capable of, configured to, or operable to support a means for outputting, via an RRC configuration message, a first information element associated with the uplink BWP or the downlink BWP, where the first information element includes an identifier of a respective downlink BWP or a respective uplink BWP that corresponds to the uplink BWP or the downlink BWP, where the uplink BWP and the respective downlink BWP or the downlink BWP and the respective uplink BWP include a BWP pairing to communicate in accordance with the full-duplex mode of operation.

In some examples, the RRC signaling component 1335 is capable of, configured to, or operable to support a means for outputting one or more RRC messages that include an RRC configuration that indicates a first set of multiple BWP pairings associated with a half-duplex mode of operation and a corresponding second set of multiple BWP pairings associated with the full-duplex mode of operation. In some examples, the BWP pairing communication component 1340 is capable of, configured to, or operable to support a means for outputting, via a DCI message, instruction to switch from a first BWP pairing to a second BWP pairing of the first set of multiple BWP pairings.

In some examples, the RRC signaling component 1335 is capable of, configured to, or operable to support a means for outputting, via an RRC message, a parameter that activates a BWP inactivity timer that is associated with switching between a default BWP and one or more active BWPs, where the BWP inactivity timer remains active after the switching.

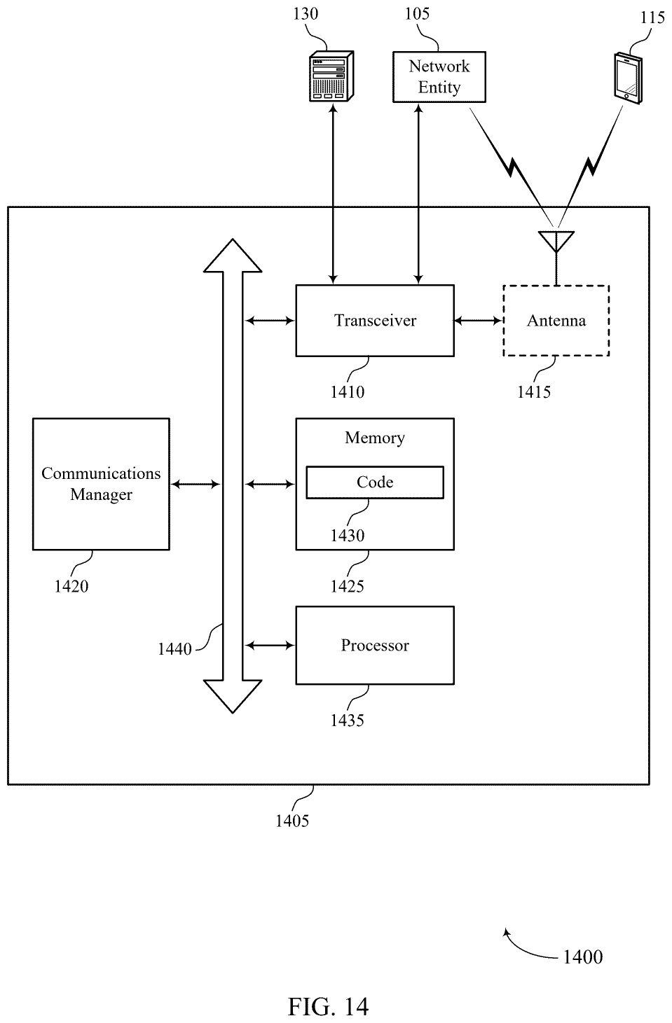

FIG. 14 shows a diagram of a system 1400 including a device 1405 that supports BWP configuration for full-duplex communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting BWP configuration for full-duplex communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network devices 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting an indication of a BWP configuration to communicate in a TDD band including at least an uplink BWP and a downlink BWP that are unaligned in center frequency. The communications manager 1420 is capable of, configured to, or operable to support a means for obtaining one or more first messages in a full-duplex mode of operation in the uplink BWP and the downlink BWP of the TDD band, where the uplink BWP and the downlink BWP are unaligned in center frequency in accordance with the BWP configuration.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, increased throughput, reduced quantity of unused frequency resources, more efficient switching between half-duplex and full-duplex modes of the UE, more efficient use of BWP resources, among other potential advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of BWP configuration for full-duplex communications as described herein, or the at least one processor 1435 and the at least one memory 1425 may be otherwise configured to, individually or collectively, perform or support such operations.

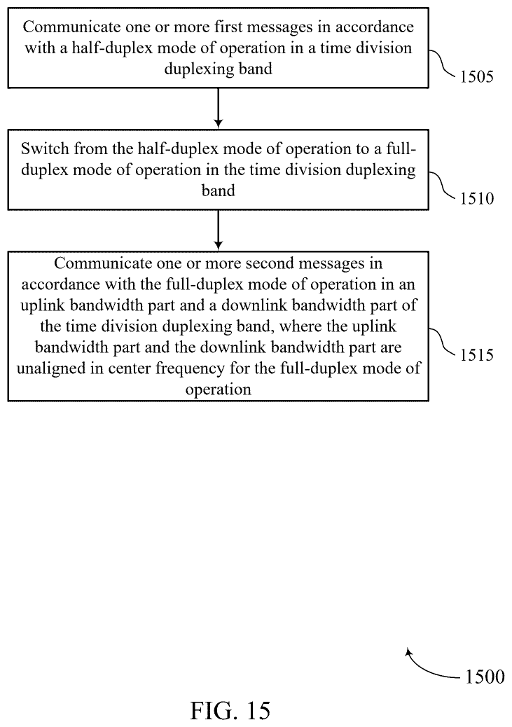

FIG. 15 shows a flowchart illustrating a method 1500 that supports BWP configuration for full-duplex communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating one or more first messages in accordance with a half-duplex mode of operation in a TDD band. The operations of 1505 may be performed in accordance with examples as disclosed herein. In some examples, aspects of the operations of 1505 may be performed by a half-duplex operation component 925 as described with reference to FIG. 9. In some examples, the operations of 1505 may be performed in accordance with examples as disclosed herein, such as half-duplex communications occurring within the uplink slot 215, the first downlink slot 210-a, and the second downlink slot 210-b described with respect to, and illustrated in, FIG. 2, or within the downlink slot and first downlink BWP 505-a and within the uplink slot and the fourth uplink BWP 510-d and the fifth uplink BWP 510-c described with respect to, and illustrated in, FIG. 5.

At 1510, the method may include switching from the half-duplex mode of operation to a full-duplex mode of operation in the TDD band. The operations of 1510 may be performed in accordance with examples as disclosed herein. In some examples, aspects of the operations of 1510 may be performed by a duplexing mode switching component 930 as described with reference to FIG. 9. In some examples, the operations of 1510 may be performed in accordance with examples as disclosed herein, such as the switch from half-duplex to full-duplex modes occurring between the uplink slot 215 and the first full-duplex slot 220-a or between the second downlink slot 210-b and the second full-duplex slot 220-b described with respect to, and illustrated in, FIG. 2, or the half-duplex to full-duplex switch that occurs during the first BWP switch 520-a described with respect to, and illustrated in, FIG. 5.

At 1515, the method may include communicating one or more second messages in accordance with the full-duplex mode of operation in an uplink BWP and a downlink BWP of the TDD band, where the uplink BWP and the downlink BWP are unaligned in center frequency for the full-duplex mode of operation. The operations of 1515 may be performed in accordance with examples as disclosed herein. In some examples, aspects of the operations of 1515 may be performed by a full-duplex operation component 935 as described with reference to FIG. 9. In some examples, the operations of 1515 may be performed in accordance with examples as disclosed herein, such as by using the downlink BWP 315 and the uplink BWP 320 that are unaligned in center frequency described with respect to, and illustrated in, FIG. 3. Some aspects of 1515 may be facilitated by the UE capability 305 described with respect to, and illustrated in, FIG. 3.

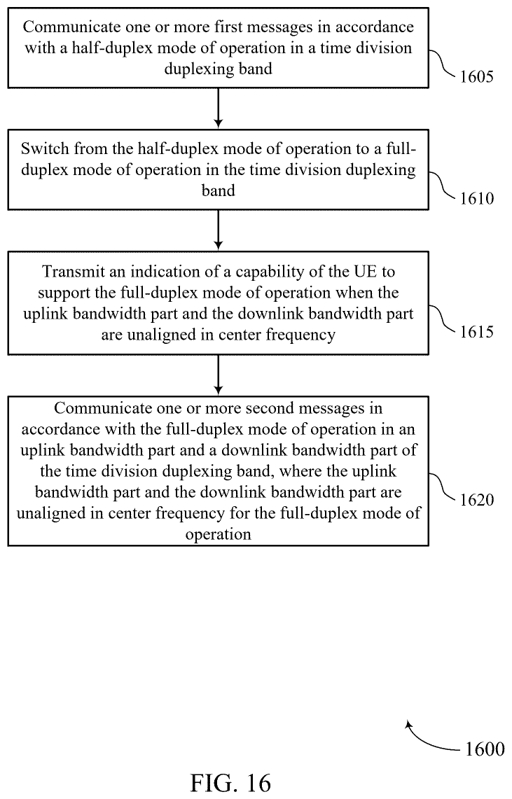

FIG. 16 shows a flowchart illustrating a method 1600 that supports BWP configuration for full-duplex communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include communicating one or more first messages in accordance with a half-duplex mode of operation in a TDD band. The operations of 1605 may be performed in accordance with examples as disclosed herein. In some examples, aspects of the operations of 1605 may be performed by a half-duplex operation component 925 as described with reference to FIG. 9. In some examples, the operations of 1605 may be performed in accordance with examples as disclosed herein, such as half-duplex communications occurring within the uplink slot 215, the first downlink slot 210-a, and the second downlink slot 210-b described with respect to, and illustrated in, FIG. 2, or within the downlink slot and first downlink BWP 505-a and within the uplink slot and the fourth uplink BWP 510-d and the fifth uplink BWP 510-c described with respect to, and illustrated in, FIG. 5.

At 1610, the method may include switching from the half-duplex mode of operation to a full-duplex mode of operation in the TDD band. The operations of 1610 may be performed in accordance with examples as disclosed herein. In some examples, aspects of the operations of 1610 may be performed by a duplexing mode switching component 930 as described with reference to FIG. 9. In some examples, the operations of 161510 may be performed in accordance with examples as disclosed herein, such as the switch from half-duplex to full-duplex modes occurring between the uplink slot 215 and the first full-duplex slot 220-a or between the second downlink slot 210-b and the second full-duplex slot 220-b described with respect to, and illustrated in, FIG. 2, or the half-duplex to full-duplex switch that occurs during the first BWP switch 520-a described with respect to, and illustrated in, FIG. 5.

At 1615, the method may include transmitting an indication of a capability of the UE to support the full-duplex mode of operation based on the uplink BWP and the downlink BWP being unaligned in center frequency. The operations of 1615 may be performed in accordance with examples as disclosed herein. In some examples, aspects of the operations of 1615 may be performed by a UE capability signaling component 940 as described with reference to FIG. 9. In some examples, the operations of 1615 may be performed in accordance with examples as disclosed herein, such as by using the downlink BWP 315 and the uplink BWP 320 that are unaligned in center frequency described with respect to, and illustrated in, FIG. 3. Some aspects of 1620 may be facilitated by the UE capability 305 described with respect to, and illustrated in, FIG. 3.

At 1620, the method may include communicating one or more second messages in accordance with the full-duplex mode of operation in an uplink BWP and a downlink BWP of the TDD band, where the uplink BWP and the downlink BWP are unaligned in center frequency for the full-duplex mode of operation. The operations of 1620 may be performed in accordance with examples as disclosed herein. In some examples, aspects of the operations of 1620 may be performed by a full-duplex operation component 935 as described with reference to FIG. 9. In some examples, the operations of 1620 may be performed in accordance with examples as disclosed herein, such as by using the downlink BWP 315 and the uplink BWP 320 that are unaligned in center frequency described with respect to, and illustrated in, FIG. 3. Some aspects of 1620 may be facilitated by the UE capability 305 described with respect to, and illustrated in, FIG. 3.

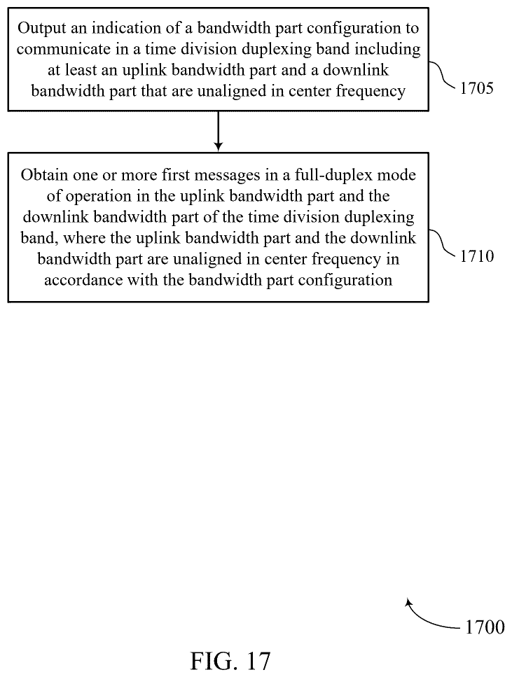

FIG. 17 shows a flowchart illustrating a method 1700 that supports BWP configuration for full-duplex communications in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting an indication of a BWP configuration to communicate in a TDD band including at least an uplink BWP and a downlink BWP that are unaligned in center frequency. The operations of 1705 may be performed in accordance with examples as disclosed herein. In some examples, aspects of the operations of 1705 may be performed by a BWP configuration component 1325 as described with reference to FIG. 13. In some examples, the operations of 1705 may be performed in accordance with examples as disclosed herein, such as by using the downlink BWP 315 and the uplink BWP 320 that are unaligned in center frequency described with respect to, and illustrated in, FIG. 3. Some aspects of 1620 may be facilitated by, for example, the network entity 105-b obtaining the UE capability 305 described with respect to, and illustrated in, FIG. 3. Some aspects of 1620 may be facilitated by, for example, the SBFD communications described with respect to, and illustrated in, FIG. 2. In some examples, the BWP configuration may be included in, for example, the RRC configuration 405 described with respect to, and illustrated in, FIG. 4.

At 1710, the method may include obtaining one or more first messages in a full-duplex mode of operation in the uplink BWP and the downlink BWP of the TDD band, where the uplink BWP and the downlink BWP are unaligned in center frequency in accordance with the BWP configuration. The operations of 1710 may be performed in accordance with examples as disclosed herein. In some examples, aspects of the operations of 1710 may be performed by a full-duplex operation component 1330 as described with reference to FIG. 13. In some examples, the operations of 1710 may be performed in accordance with examples as disclosed herein, such as by using the downlink BWP 315 and the uplink BWP 320 that are unaligned in center frequency described with respect to, and illustrated in, FIG. 3. Some aspects of 1620 may be facilitated by, for example, the network entity 105-b obtaining the UE capability 305 described with respect to, and illustrated in, FIG. 3. Some aspects of 1620 may be facilitated by, for example, the SBFD communications described with respect to, and illustrated in, FIG. 2.

The following provides an overview of aspects of the present disclosure:

Aspect 1: A method for wireless communications at a UE, comprising: communicating one or more first messages in accordance with a half-duplex mode of operation in a TDD band; switching from the half-duplex mode of operation to a full-duplex mode of operation in the TDD band; and communicating one or more second messages in accordance with the full-duplex mode of operation in an uplink BWP and a downlink BWP of the TDD band, wherein the uplink BWP and the downlink BWP are unaligned in center frequency for the full-duplex mode of operation.

Aspect 2: The method of aspect 1, further comprising: transmitting an indication of a capability of the UE to support the full-duplex mode of operation based at least in part on the uplink BWP and the downlink BWP being unaligned in center frequency.

Aspect 3: The method of any of aspects 1 through 2, wherein the uplink BWP and the downlink BWP are associated with a same BWP identifier.

Aspect 4: The method of any of aspects 1 through 3, wherein communicating the one or more second messages comprises: receiving one or more RRC messages that include an RRC configuration that indicates a first plurality of BWP pairings associated with the half-duplex mode of operation and a second plurality of BWP pairings associated with the full-duplex mode of operation; and communicating the one or more second messages in accordance with a first BWP pairing of the second plurality of BWP pairings associated with the full-duplex mode of operation, wherein the first BWP pairing includes the uplink BWP and the downlink BWP.

Aspect 5: The method of aspect 4, wherein the first plurality of BWP pairings and the second plurality of BWP pairings are included in a lookup table as part of the one or more RRC messages.

Aspect 6: The method of any of aspects 4 through 5, further comprising: switching from the first BWP pairing of the second plurality of BWP pairings to a second BWP pairing of the first plurality of BWP pairings based at least in part on a corresponding switch from a full duplex slot to a half-duplex slot.

Aspect 7: The method of any of aspects 4 through 6, wherein the first plurality of BWP pairings and the second plurality of BWP pairings are associated with different respective communication beams, different respective power control parameters, or both.

Aspect 8: The method of any of aspects 1 through 7, further comprising: receiving, via an RRC configuration message, a first information element associated with the uplink BWP, wherein the first information element includes an identifier of a respective downlink BWP that corresponds to the uplink BWP, wherein the uplink BWP and the respective downlink BWP comprise a BWP pairing to communicate in accordance with the full-duplex mode of operation.

Aspect 9: The method of any of aspects 1 through 8, further comprising: receiving, via an RRC configuration message, a first information element associated with the downlink BWP, wherein the first information element includes an identifier of a respective uplink BWP that corresponds to the downlink BWP, wherein the downlink BWP and the respective uplink BWP comprise a BWP pairing to communicate in accordance with the full-duplex mode of operation.

Aspect 10: The method of any of aspects 1 through 9, further comprising: receiving one or more RRC messages that include an RRC configuration that indicates a first plurality of BWP pairings associated with the half-duplex mode of operation and a corresponding second plurality of BWP pairings associated with the full-duplex mode of operation; receiving, via a downlink control information message, instruction to switch from a first BWP pairing to a second BWP pairing of the first plurality of BWP pairings; and switching from a first corresponding BWP pairing to a second corresponding BWP pairing of the corresponding second plurality of BWP pairings based at least in part on the downlink control information message.

Aspect 11: The method of any of aspects 1 through 10, further comprising: receiving, via an RRC message, a parameter that activates a timer that is associated with switching between a default BWP and one or more active BWPs; and switching from a first active BWP pairing of a half-duplex slot to a second active BWP pairing of a full-duplex slot, wherein the timer remains active after the switching.

Aspect 12: The method of aspect 11, wherein the timer comprises a BWP inactivity timer.

Aspect 13: The method of any of aspects 11 through 12, wherein the timer remaining active comprises: refraining from restarting the timer based at least in part on switching a slot type from the half-duplex slot to the full-duplex slot.

Aspect 14: A method for wireless communications at a network entity, comprising: outputting an indication of a BWP configuration to communicate in a TDD band including at least an uplink BWP and a downlink BWP that are unaligned in center frequency; and obtaining one or more first messages in a full-duplex mode of operation in the uplink BWP and the downlink BWP of the TDD band, wherein the uplink BWP and the downlink BWP are unaligned in center frequency in accordance with the BWP configuration.

Aspect 15: The method of aspect 14, further comprising: obtaining an indication of a capability of a UE to support the full-duplex mode of operation based at least in part on the uplink BWP and the downlink BWP being unaligned in center frequency, wherein the uplink BWP and the downlink BWP are associated with a same BWP identifier.

Aspect 16: The method of any of aspects 14 through 15, wherein communicating the one or more first messages comprises: outputting one or more RRC messages that include an RRC configuration that indicates a lookup table comprising a first plurality of BWP pairings associated with a half-duplex mode of operation and a second plurality of BWP pairings associated with the full-duplex mode of operation; and obtaining the one or more first messages in accordance with a first BWP pairing of the second plurality of BWP pairings associated with the full-duplex mode of operation, wherein the first BWP pairing includes the uplink BWP and the downlink BWP.

Aspect 17: The method of any of aspects 14 through 16, further comprising: outputting, via an RRC configuration message, a first information element associated with the uplink BWP or the downlink BWP, wherein the first information element includes an identifier of a respective downlink BWP or a respective uplink BWP that corresponds to the uplink BWP or the downlink BWP, wherein the uplink BWP and the respective downlink BWP or the downlink BWP and the respective uplink BWP comprise a BWP pairing to communicate in accordance with the full-duplex mode of operation.

Aspect 18: The method of any of aspects 14 through 17, further comprising: outputting one or more RRC messages that include an RRC configuration that indicates a first plurality of BWP pairings associated with a half-duplex mode of operation and a corresponding second plurality of BWP pairings associated with the full-duplex mode of operation; and outputting, via a downlink control information message, instruction to switch from a first BWP pairing to a second BWP pairing of the first plurality of BWP pairings.

Aspect 19: The method of any of aspects 14 through 18, further comprising: outputting, via an RRC message, a parameter that activates a BWP inactivity timer that is associated with switching between a default BWP and one or more active BWPs, wherein the BWP inactivity timer remains active after the switching.

Aspect 20: A UE for wireless communications, comprising one or more memories storing processor-executable code, and one or more processors coupled with the one or more memories and individually or collectively operable to execute the code to cause the UE to perform a method of any of aspects 1 through 13.

Aspect 21: A UE for wireless communications, comprising at least one means for performing a method of any of aspects 1 through 13.

Aspect 22: A non-transitory computer-readable medium storing code for wireless communications, the code comprising instructions executable by one or more processors to perform a method of any of aspects 1 through 13.

Aspect 23: A network entity for wireless communications, comprising one or more memories storing processor-executable code, and one or more processors coupled with the one or more memories and individually or collectively operable to execute the code to cause the network entity to perform a method of any of aspects 14 through 19.

Aspect 24: A network entity for wireless communications, comprising at least one means for performing a method of any of aspects 14 through 19.

Aspect 25: A non-transitory computer-readable medium storing code for wireless communications, the code comprising instructions executable by one or more processors to perform a method of any of aspects 14 through 19.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate one or more first messages in accordance with a half-duplex mode of operation in a time division duplexing band;
switch from the half-duplex mode of operation to a full-duplex mode of operation in the time division duplexing band; and
communicate one or more second messages in accordance with the full-duplex mode of operation in an uplink bandwidth part and a downlink bandwidth part of the time division duplexing band, wherein the uplink bandwidth part and the downlink bandwidth part are unaligned in center frequency for the full-duplex mode of operation.

2. The UE of claim 1, wherein the one or more processors are individually or collectively further operable to execute the code to cause the UE to:
transmit an indication of a capability of the UE to support the full-duplex mode of operation based at least in part on the uplink bandwidth part and the downlink bandwidth part being unaligned in center frequency.

3. The UE of claim 1, wherein the uplink bandwidth part and the downlink bandwidth part are associated with a same bandwidth part identifier.

4. The UE of claim 1, wherein, to communicate the one or more second messages, the one or more processors are individually or collectively operable to execute the code to cause the UE to:
receive one or more radio resource control messages that include a radio resource control configuration that indicates a first plurality of bandwidth part pairings associated with the half-duplex mode of operation and a second plurality of bandwidth part pairings associated with the full-duplex mode of operation; and
communicate the one or more second messages in accordance with a first bandwidth part pairing of the second plurality of bandwidth part pairings associated with the full-duplex mode of operation, wherein the first bandwidth part pairing includes the uplink bandwidth part and the downlink bandwidth part.

5. The UE of claim 4, wherein the first plurality of bandwidth part pairings and the second plurality of bandwidth part pairings are included in a lookup table as part of the one or more radio resource control messages.

6. The UE of claim 4, wherein the one or more processors are individually or collectively further operable to execute the code to cause the UE to:
switch from the first bandwidth part pairing of the second plurality of bandwidth part pairings to a second bandwidth part pairing of the first plurality of bandwidth part pairings based at least in part on a corresponding switch from a full-duplex slot to a half-duplex slot.

7. The UE of claim 4, wherein the first plurality of bandwidth part pairings and the second plurality of bandwidth part pairings are associated with different respective communication beams, different respective power control parameters, or both.

8. The UE of claim 1, wherein the one or more processors are individually or collectively further operable to execute the code to cause the UE to:
receive, via a radio resource control configuration message, a first information element associated with the uplink bandwidth part, wherein the first information element includes an identifier of a respective downlink bandwidth part that corresponds to the uplink bandwidth part, wherein the uplink bandwidth part and the respective downlink bandwidth part comprise a bandwidth part pairing to communicate in accordance with the full-duplex mode of operation.

9. The UE of claim 1, wherein the one or more processors are individually or collectively further operable to execute the code to cause the UE to:
receive, via a radio resource control configuration message, a first information element associated with the downlink bandwidth part, wherein the first information element includes an identifier of a respective uplink bandwidth part that corresponds to the downlink bandwidth part, wherein the downlink bandwidth part and the respective uplink bandwidth part comprise a bandwidth part pairing to communicate in accordance with the full-duplex mode of operation.

10. The UE of claim 1, wherein the one or more processors are individually or collectively further operable to execute the code to cause the UE to:
receive one or more radio resource control messages that include a radio resource control configuration that indicates a first plurality of bandwidth part pairings associated with the half-duplex mode of operation and a corresponding second plurality of bandwidth part pairings associated with the full-duplex mode of operation;
receive, via a downlink control information message, instruction to switch from a first bandwidth part pairing to a second bandwidth part pairing of the first plurality of bandwidth part pairings; and
switch from a first corresponding bandwidth part pairing to a second corresponding bandwidth part pairing of the corresponding second plurality of bandwidth part pairings based at least in part on the downlink control information message.

11. The UE of claim 1, wherein the one or more processors are individually or collectively further operable to execute the code to cause the UE to:
receive, via a radio resource control message, a parameter that activates a timer that is associated with switching between a default bandwidth part and one or more active bandwidth parts; and
switch from a first active bandwidth part pairing of a half-duplex slot to a second active bandwidth part pairing of a full-duplex slot, wherein the timer remains active after the switching.

12. The UE of claim 11, wherein the timer comprises a bandwidth part inactivity timer.

13. The UE of claim 11, wherein, to timer remain active, the one or more processors are individually or collectively operable to execute the code to cause the UE to:
refrain from restarting the timer based at least in part on switching a slot type from the half-duplex slot to the full-duplex slot.

14. A network entity, comprising:
one or more memories storing processor-executable code; and
one or more processors coupled with the one or more memories and individually or collectively operable to execute the code to cause the network entity to:
output an indication of a bandwidth part configuration to communicate in a time division duplexing band including at least an uplink bandwidth part and a downlink bandwidth part that are unaligned in center frequency; and
obtain one or more first messages in a full-duplex mode of operation in the uplink bandwidth part and the downlink bandwidth part of the time division duplexing band, wherein the uplink bandwidth part and the downlink bandwidth part are unaligned in center frequency in accordance with the bandwidth part configuration.

15. The network entity of claim 14, wherein the one or more processors are individually or collectively further operable to execute the code to cause the network entity to:
obtain an indication of a capability of a user equipment (UE) to support the full-duplex mode of operation based at least in part on the uplink bandwidth part and the downlink bandwidth part being unaligned in center frequency, wherein the uplink bandwidth part and the downlink bandwidth part are associated with a same bandwidth part identifier.

16. The network entity of claim 14, wherein, to communicate the one or more first messages, the one or more processors are individually or collectively operable to execute the code to cause the network entity to:
output one or more radio resource control messages that include a radio resource control configuration that indicates a lookup table comprising a first plurality of bandwidth part pairings associated with a half-duplex mode of operation and a second plurality of bandwidth part pairings associated with the full-duplex mode of operation; and
obtain the one or more first messages in accordance with a first bandwidth part pairing of the second plurality of bandwidth part pairings associated with the full-duplex mode of operation, wherein the first bandwidth part pairing includes the uplink bandwidth part and the downlink bandwidth part.

17. The network entity of claim 14, wherein the one or more processors are individually or collectively further operable to execute the code to cause the network entity to:
output, via a radio resource control configuration message, a first information element associated with the uplink bandwidth part or the downlink bandwidth part, wherein the first information element includes an identifier of a respective downlink bandwidth part or a respective uplink bandwidth part that corresponds to the uplink bandwidth part or the downlink bandwidth part, wherein the uplink bandwidth part and the respective downlink bandwidth part or the downlink bandwidth part and the respective uplink bandwidth part comprise a bandwidth part pairing to communicate in accordance with the full-duplex mode of operation.

18. The network entity of claim 14, wherein the one or more processors are individually or collectively further operable to execute the code to cause the network entity to:
output one or more radio resource control messages that include a radio resource control configuration that indicates a first plurality of bandwidth part pairings associated with a half-duplex mode of operation and a corresponding second plurality of bandwidth part pairings associated with the full-duplex mode of operation; and
output, via a downlink control information message, instruction to switch from a first bandwidth part pairing to a second bandwidth part pairing of the first plurality of bandwidth part pairings.

19. The network entity of claim 14, wherein the one or more processors are individually or collectively further operable to execute the code to cause the network entity to:
output, via a radio resource control message, a parameter that activates a bandwidth part inactivity timer that is associated with switching between a default bandwidth part and one or more active bandwidth parts, wherein the bandwidth part inactivity timer remains active after the switching.

20. A method for wireless communications at a user equipment (UE), comprising:
communicating one or more first messages in accordance with a half-duplex mode of operation in a time division duplexing band;
switching from the half-duplex mode of operation to a full-duplex mode of operation in the time division duplexing band; and
communicating one or more second messages in accordance with the full-duplex mode of operation in an uplink bandwidth part and a downlink bandwidth part of the time division duplexing band, wherein the uplink bandwidth part and the downlink bandwidth part are unaligned in center frequency for the full-duplex mode of operation.
